(19) United States
(12) Patent Application Publication
(10) Pub. No.: US 2025/0039893 A1
(43) Pub. Date: Jan. 30, 2025

(54) CONFIGURATION OF CANDIDATE TRANSMISSION CONFIGURATION INDICATOR STATES

(71) Applicant: QUALCOMM Incorporated, San Diego, CA (US)

(72) Inventors: Ruiming ZHENG, Beijing (CN); Yan ZHOU, San Diego, CA (US); Ozcan OZTURK, San Diego, CA (US); Linhai HE, San Diego, CA (US); Tao LUO, San Diego, CA (US)

(21) Appl. No.: 18/710,826

(22) PCT Filed: Jan. 6, 2022
(86) PCT No.: PCT/CN2022/070498

§ 371 Date: May 16, 2024

(51) Int. Cl. H04W 72/231; H04L 5/00

(52) U.S. Cl. CPC H04W 72/231; H04L 5/0094

(57) ABSTRACT

Various aspects of the present disclosure generally relate to wireless communication. In some aspects, a user equipment (UE) may receive an indication of candidate transmission configuration indicator (TCI) states for communicating with one or more base stations. The CE may receive an indication of a subset of the candidate TCI states for selection for a communication with the one or more base stations, the indication of the subset including an indication of whether one or more candidate TCI states of the subset of the candidate TCI states are joint uplink/downlink candidate TCI states. Numerous other aspects are described.

### FIELD OF THE DISCLOSURE

Aspects of the present disclosure generally relate to wireless communication and to techniques and apparatuses for configuring candidate transmission configuration indicator states.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving an indication of candidate transmission configuration indicator (TCI) states for communicating with one or more base stations. The method may include receiving an indication of a subset of the candidate TCI states for selection for a communication with the one or more base stations, the indication of the subset including an indication of whether one or more candidate TCI states of the subset of the candidate TCI states are joint uplink/downlink candidate TCI states.

Some aspects described herein relate to a method of wireless communication performed by a base station. The method may include transmitting an indication of candidate TCI states for communicating with one or more base stations. The method may include transmitting an indication of a subset of the candidate TCI states for selection for a communication with the one or more base stations, the indication of the subset including an indication of whether one or more candidate TCI states of the subset of the candidate TCI states are joint uplink/downlink candidate TCI states.

Some aspects described herein relate to a method of wireless communication performed by a UE. The method may include receiving an indication of candidate TCI states for selection for a communication with one or more base stations. The method may include receiving a control message that indicates one or more of the candidate TCI states that are updated and that indicates an update to the one or more of the candidate TCI states.

Some aspects described herein relate to a method of wireless communication performed by a base station. The method may include transmitting an indication of candidate TCI states for selection for a communication with one or more base stations. The method may include transmitting a control message that indicates one or more of the candidate TCI states that are updated and that indicates an update to the one or more of the candidate TCI states.

Some aspects described herein relate to a UE for wireless communication. The user equipment may include a memory and one or more processors coupled to the memory. The one or more processors may be configured to receive an indication of candidate TCI states for communicating with one or more base stations. The one or more processors may be configured to receive an indication of a subset of the candidate TCI states for selection for a communication with the one or more base stations, the indication of the subset including an indication of whether one or more candidate TCI states of the subset of the candidate TCI states are joint uplink/downlink candidate TCI states.

Some aspects described herein relate to a base station for wireless communication. The base station may include a memory and one or more processors coupled to the memory. The one or more processors may be configured to transmit an indication of candidate TCI states for communicating with one or more base stations. The one or more processors may be configured to transmit an indication of a subset of the candidate TCI states for selection for a communication with the one or more base stations, the indication of the subset including an indication of whether one or more candidate TCI states of the subset of the candidate TCI states are joint uplink/downlink candidate TCI states.

Some aspects described herein relate to a UE for wireless communication. The UE may include a memory and one or more processors coupled to the memory. The one or more processors may be configured to receive an indication of candidate TCI states for selection for a communication with one or more base stations. The one or more processors may be configured to receive a control message that indicates one or more of the candidate TCI states that are updated and that indicates an update to the one or more of the candidate TCI states.

Some aspects described herein relate to a base station for wireless communication. The base station may include a memory and one or more processors coupled to the memory. The one or more processors may be configured to transmit an indication of candidate TCI states for selection for a communication with one or more base stations. The one or more processors may be configured to transmit a control message that indicates one or more of the candidate TCI states that are updated and that indicates an update to the one or more of the candidate TCI states.

Some aspects described herein relate to a non-transitory computer-readable medium that stores a set of instructions for wireless communication by a UE. The set of instructions, when executed by one or more processors of the UE, may cause the UE to receive an indication of candidate TCI states for communicating with one or more base stations. The set of instructions, when executed by one or more processors of the UE, may cause the UE to receive an indication of a subset of the candidate TCI states for selection for a communication with the one or more base stations, the indication of the subset including an indication of whether one or more candidate TCI states of the subset of the candidate TCI states are joint uplink/downlink candidate TCI states.

Some aspects described herein relate to a non-transitory computer-readable medium that stores a set of instructions for wireless communication by a base station. The set of instructions, when executed by one or more processors of the base station, may cause the base station to transmit an indication of candidate TCI states for communicating with one or more base stations. The set of instructions, when executed by one or more processors of the base station, may cause the base station to transmit an indication of a subset of the candidate TCI states for selection for a communication with the one or more base stations, the indication of the subset including an indication of whether one or more candidate TCI states of the subset of the candidate TCI states are joint uplink/downlink candidate TCI states.

Some aspects described herein relate to a non-transitory computer-readable medium that stores a set of instructions for wireless communication by a one or more instructions that, when executed by one or more processors of an UE. The set of instructions, when executed by one or more processors of the one or more instructions that, when executed by one or more processors of an UE, may cause the one or more instructions that, when executed by one or more processors of an UE to receive an indication of candidate TCI states for selection for a communication with one or more base stations. The set of instructions, when executed by one or more processors of the one or more instructions that, when executed by one or more processors of an UE, may cause the one or more instructions that, when executed by one or more processors of an UE to receive a control message that indicates one or more of the candidate TCI states that are updated and that indicates an update to the one or more of the candidate TCI states.

Some aspects described herein relate to a non-transitory computer-readable medium that stores a set of instructions for wireless communication by a base station. The set of instructions, when executed by one or more processors of the base station, may cause the base station to transmit an indication of candidate TCI states for selection for a communication with one or more base stations. The set of instructions, when executed by one or more processors of the base station, may cause the base station to transmit a control message that indicates one or more of the candidate TCI states that are updated and that indicates an update to the one or more of the candidate TCI states.

Some aspects described herein relate to an apparatus for wireless communication. The apparatus may include means for receiving an indication of candidate TCI states for communicating with one or more base stations. The apparatus may include means for receiving an indication of a subset of the candidate TCI states for selection for a communication with the one or more base stations, the indication of the subset including an indication of whether one or more candidate TCI states of the subset of the candidate TCI states are joint uplink/downlink candidate TCI states.

Some aspects described herein relate to an apparatus for wireless communication. The apparatus may include means for transmitting an indication of candidate TCI states for communicating with one or more base stations. The apparatus may include means for transmitting an indication of a subset of the candidate TCI states for selection for a communication with the one or more base stations, the indication of the subset including an indication of whether one or more candidate TCI states of the subset of the candidate TCI states are joint uplink/downlink candidate TCI states.

Some aspects described herein relate to an apparatus for wireless communication. The apparatus may include means for receiving an indication of candidate TCI states for selection for a communication with one or more base stations. The apparatus may include means for receiving a control message that indicates one or more of the candidate TCI states that are updated and that indicates an update to the one or more of the candidate TCI states.

Some aspects described herein relate to an apparatus for wireless communication. The apparatus may include means for transmitting an indication of candidate TCI states for selection for a communication with one or more base stations. The apparatus may include means for transmitting a control message that indicates one or more of the candidate TCI states that are updated and that indicates an update to the one or more of the candidate TCI states.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of transmission configuration indicator (TCI) state configuration, in accordance with the present disclosure.

FIG. 4 is a diagram illustrating an example associated with configuring candidate transmission configuration indicator states, in accordance with the present disclosure.

FIGS. 5A-5I are diagrams illustrating examples associated with a control message associated with configuring candidate transmission configuration indicator states, in accordance with the present disclosure.

FIGS. 6-9 are diagrams illustrating example processes associated with configuring candidate transmission configuration indicator states, in accordance with the present disclosure.

FIGS. 10-11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

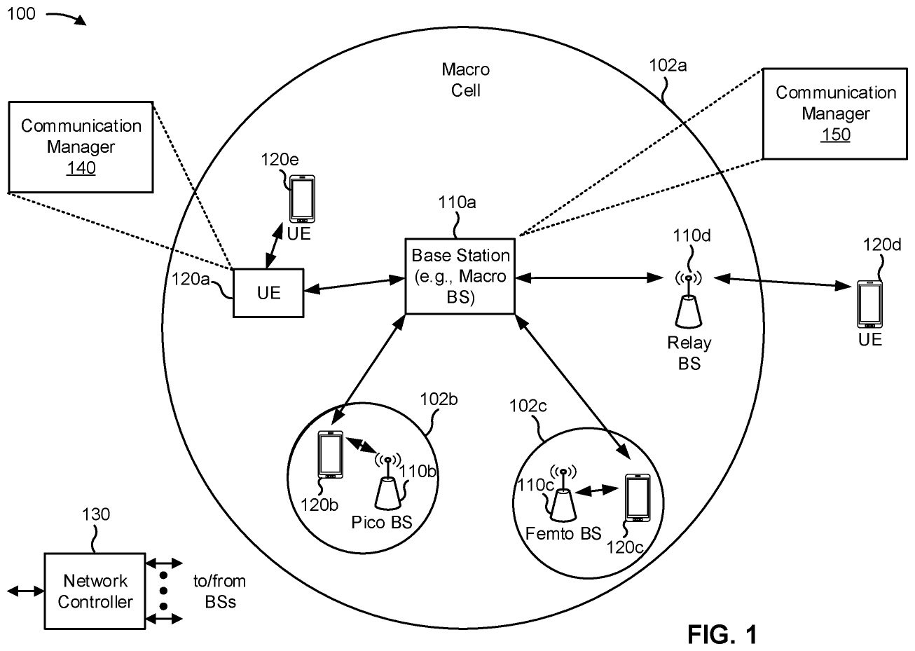

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHZ-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication of candidate TCI states for communicating with one or more base stations; and receive an indication of a subset of the candidate TCI states for selection for a communication with the one or more base stations, the indication of the subset including an indication of whether one or more candidate TCI states of the subset of the candidate TCI states are joint uplink/downlink candidate TCI states. Additionally, or alternatively, the communication manager 140 may perform one or more other operations described herein.

In some aspects, the base station 110 may include a communication manager 150. As described in more detail elsewhere herein, the communication manager 150 may transmit an indication of candidate TCI states for communicating with one or more base stations; and transmit an indication of a subset of the candidate TCI states for selection for a communication with the one or more base stations, the indication of the subset including an indication of whether one or more candidate TCI states of the subset of the candidate TCI states are joint uplink/downlink candidate TCI states. Additionally, or alternatively, the communication manager 150 may perform one or more other operations described herein.

In some aspects, the UE 120 may include a communication manager 140. As described in more detail elsewhere herein, the communication manager 140 may receive an indication of candidate TCI states for selection for a communication with one or more base stations; and receive a control message that indicates one or more of the candidate TCI states that are updated and that indicates an update to the one or more of the candidate TCI states. Additionally, or alternatively, the communication manager 140 may perform one or more other operations described herein.

In some aspects, the base station 110 may include a communication manager 150. As described in more detail elsewhere herein, the communication manager 150 may transmit an indication of candidate TCI states for selection for a communication with one or more base stations; and transmit a control message that indicates one or more of the candidate TCI states that are updated and that indicates an update to the one or more of the candidate TCI states. Additionally, or alternatively, the communication manager 150 may perform one or more other operations described herein.

As indicated above, FIG. 1 is provided as an example. Other examples may differ from what is described with regard to FIG. 1.

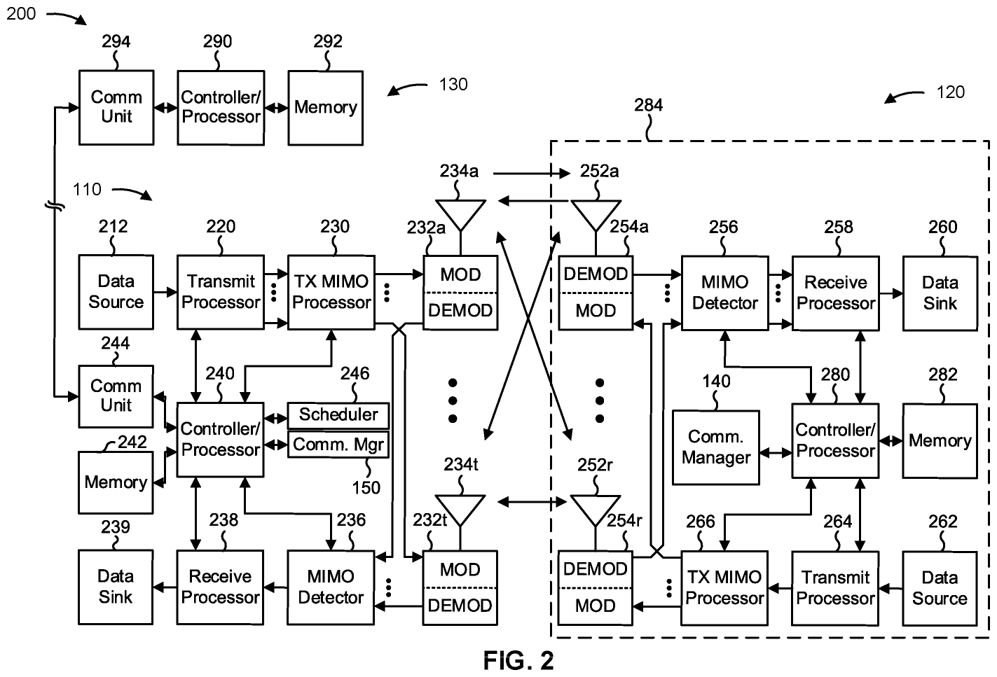

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

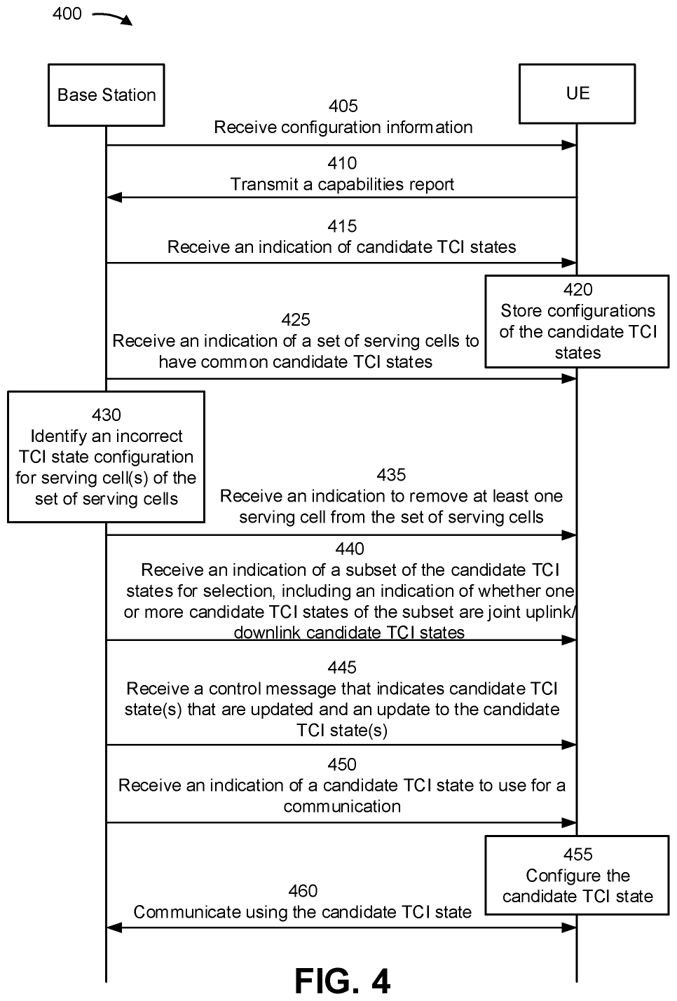

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-11).

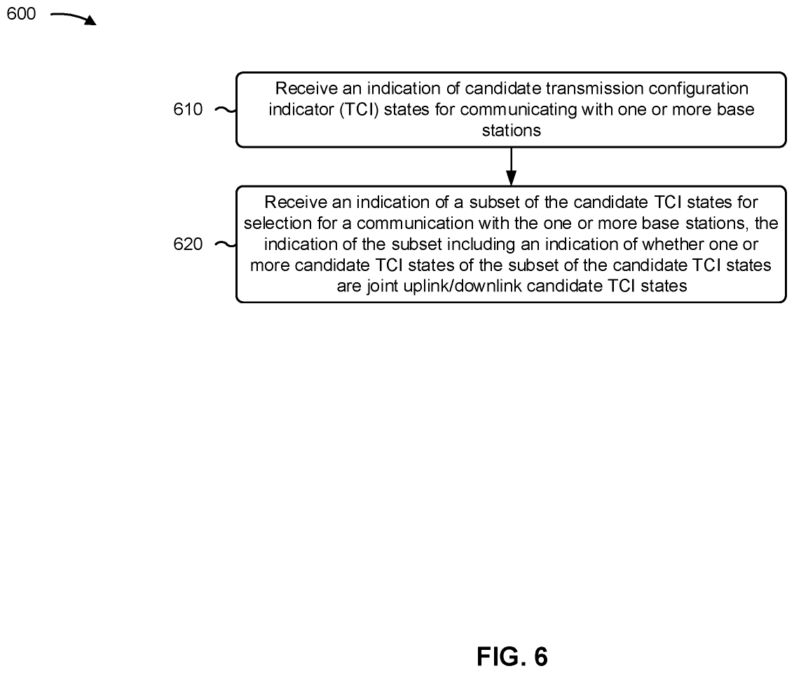

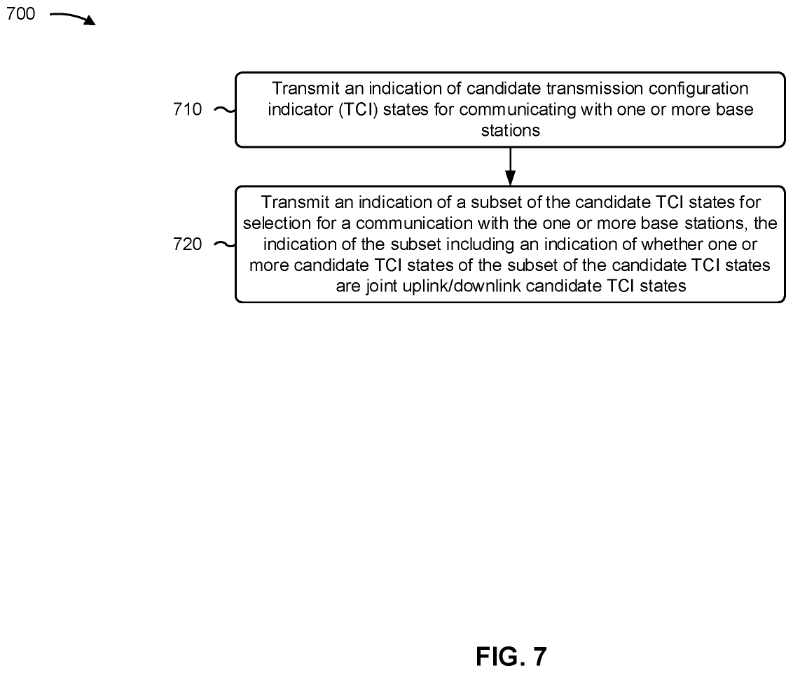

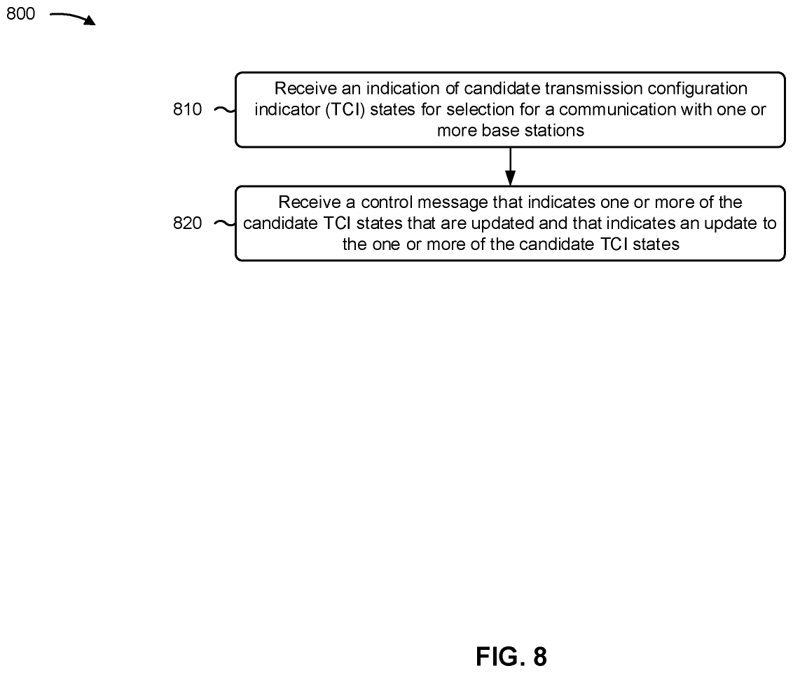

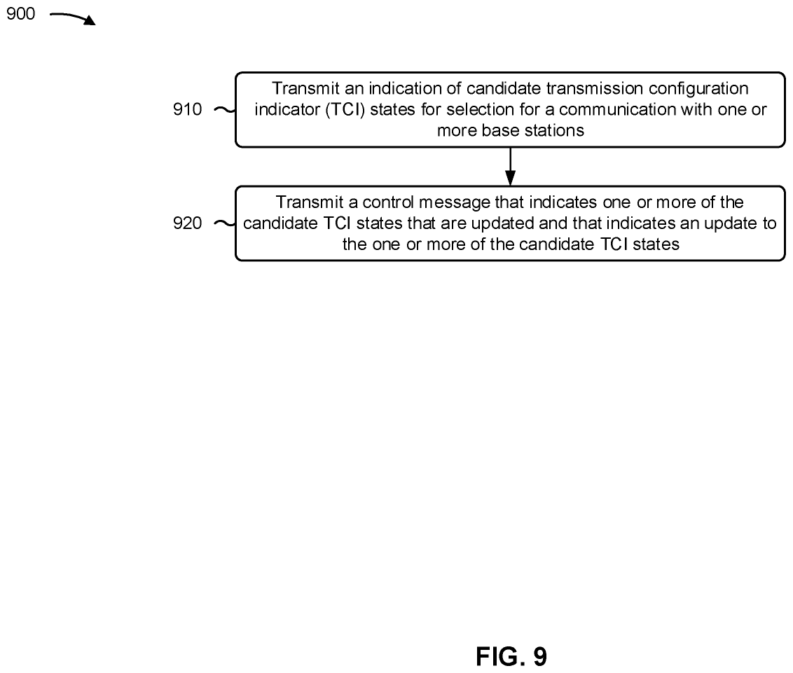

The controller/processor 240 of the base station 110, the controller/processor 280 of the UE 120, and/or any other component(s) of FIG. 2 may perform one or more techniques associated with configuring candidate transmission configuration indicator states, as described in more detail elsewhere herein. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE includes means for receiving an indication of candidate TCI states for communicating with one or more base stations; and/or means for receiving an indication of a subset of the candidate TCI states for selection for a communication with the one or more base stations, the indication of the subset including an indication of whether one or more candidate TCI states of the subset of the candidate TCI states are joint uplink/downlink candidate TCI states. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for transmitting an indication of candidate TCI states for communicating with one or more base stations; and/or means for transmitting an indication of a subset of the candidate TCI states for selection for a communication with the one or more base stations, the indication of the subset including an indication of whether one or more candidate TCI states of the subset of the candidate TCI states are joint uplink/downlink candidate TCI states. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the UE includes means for receiving an indication of candidate TCI states for selection for a communication with one or more base stations; and/or means for receiving a control message that indicates one or more of the candidate TCI states that are updated and that indicates an update to the one or more of the candidate TCI states. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for transmitting an indication of candidate TCI states for selection for a communication with one or more base stations; and/or means for transmitting a control message that indicates one or more of the candidate TCI states that are updated and that indicates an update to the one or more of the candidate TCI states. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

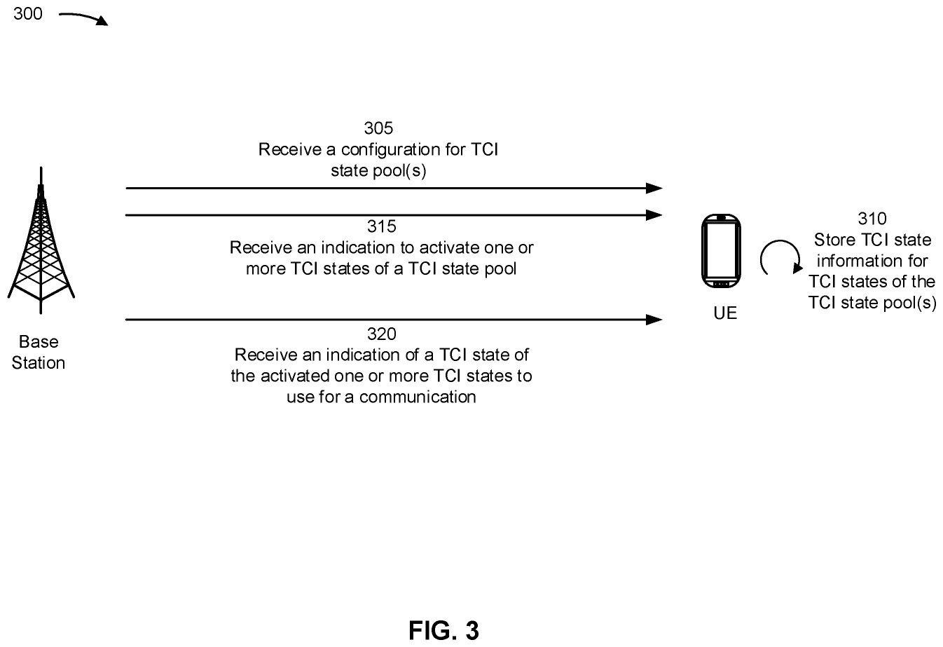

FIG. 3 is a diagram illustrating an example of TCI state configuration, in accordance with the present disclosure. As shown in FIG. 3, a base station and a UE may communicate via a wireless connection. The UE and the base station may have established a wireless connection prior to the operations described in connection with FIG. 3.

As shown by reference number 305, the UE may receive, and the base station may transmit, a configuration for one or more TCI state pools. The one or more TCI state pools may be separated based at least in part on TCI types, such as UL only, DL only, and/or joint UL and DL TCI types. The UE may receive the configuration via radio resource control (RRC) signaling.

As shown by reference number 310, the UE may store TCI state information for TCI states of the one or more TCI state pools.

As shown by reference number 315, the UE may receive, and the base station may transmit an indication to activate one or more TCI states of a TCI state pool configured in connection with reference number 305. For example, the UE may receive an indication of activation of up to 8, for example, TCI states that are selectable via a subsequent indication. The UE may receive that indication via medium access control (MAC) control element (CE) signaling.

As shown by reference number 320, the UE may receive, and the base station may transmit, an indication of a TCI state of the activated one or more TCI states to use for a communication. For example, the UE may receive the indication of the TCI state via downlink control information (DCI).

The UE and the base station may communicate based at least in part on the UE applying the TCI state to transmitting and/or receiving subsequent communications with the base station.

For unified TCI signaling, the UE and the base station may configure a TCI state using a similar process. For example, the UE may receive a MAC CE that activates one or more TCI states from a TCI state pool that is RRC configured. If multiple TCI states are activated, DCI (for example, DCI format 1_1 and 1_2) may be used to select one TCI state among activated TCI states.

The MAC CE may activate up to 8 TCI states for a UE-dedicated channel and/or signals beam indication. The beam indication may be a joint beam indication (e.g., a joint DL/UL TCI state) or a separate beam indication (e.g., DL only TCI state, UL only TCI state, or DL only+UL only TCI state).

Unified TCI state signaling may be used to reduce a number of MAC CE messages that are used to activate and/or update TCI states for selection by a subsequent DCI message. However, a format of the MAC CE messages that supports individual fields for each TCI state pool and/or for each TCI state type may consume an unnecessary amount of processing, network, communication, and power resources for the MAC CE messages.

In some aspects described herein, a UE may receive, and a base station may transmit, an indication of candidate TCI states for communicating with one or more base stations (e.g., one or more TRPs associated with a base station). The UE may further receive, and the base station may transmit, an indication of a subset of the candidate TCI states for selection for a communication with the one or more base stations. The indication of the subset may include an indication of whether one or more candidate TCI states of the subset of the candidate TCI states are joint uplink/downlink candidate TCI states, whether one or more previously configured candidate TCI states are updated via the control message, an indication of an update to the one or more previously configured candidate TCI states, and/or an indication of a type of TCI state that is indicated in the subset of the candidate TCI states, among other examples. The UE and the base station may use one or more of these indications to reduce an amount of bits used in the indication of the subset to indicate one or more types of TCI states that are activated, deactivated, and/or updated via the indication of the subset. In this way, the UE and the base station may conserve processing, network, communication, and power resources for the indication of the subset of the candidate TCI states (e.g., a MAC CE message or other control message) that may otherwise be used to support individual fields for each TCI state pool and/or for each TCI state type.

FIG. 4 is a diagram of an example 400 associated with configuring candidate TCI states, in accordance with the present disclosure. As shown in FIG. 4, a base station (e.g., base station 110) may communicate with a UE (e.g., UE 120). In some aspects, the base station and the UE may be part of a wireless network (e.g., wireless network 100). The UE and the base station may have established a wireless connection prior to operations shown in FIG. 4. The description of FIG. 4 and subsequent figures describe TCI states. However, the term TCI states may be also apply to spatial relation information.

As shown by reference number 405, the base station may transmit, and the UE may receive, configuration information. In some aspects, the UE may receive the configuration information via one or more of RRC signaling, one or more MAC CEs, and/or DCI, among other examples. In some aspects, the configuration information may include an indication of one or more configuration parameters (e.g., already known to the UE and/or previously indicated by the base station or other network device) for selection by the UE, and/or explicit configuration information for the UE to use to configure the UE, among other examples.

In some aspects, the configuration information may indicate that the UE is to communicate using TCI states that are to be configured via first communication, activated via a second communication, and/or selected via a third communication or the second communication. In some aspects, the configuration information may indicate whether TCI states of different TCI state types are to be configured within a common pool or separate pools of candidate TCI states. In some aspects, the configuration information may indicate a format for indicating a subset of the TCI states for selection (e.g., the second communication, a MAC CE, and/or a control message, among other examples). The format may be based at least in part on a pooling configuration for pooling the candidate TCI states.

The UE may configure itself based at least in part on the configuration information. In some aspects, the UE may be configured to perform one or more operations described herein based at least in part on the configuration information.

As shown by reference number 410, the UE may transmit, and the base station may receive, a capabilities report. In some aspects, the capabilities report may indicate UE support for communicating according to the configuration information indicated in connection with reference number 405. In some aspects, the capabilities report may indicate whether the UE supports a pool of candidate TCI states that includes multiple TCI types (e.g., UL only, DL only, joint UL and DL, or separate UL and separate DL, among other examples).

As shown by reference number 415, the UE may receive, and the base station may transmit, an indication of candidate TCI states. For example, the UE may receive the indication of the candidate TCI states via RRC signaling. The indication of the candidate TCI states as an indication of candidate TCI states within a pool of candidate TCI states. For example, the candidate TCI states include TCI states for one or more of UL only candidate TCI states, DL only candidate TCI states, or joint UL/DL candidate TCI states (TCI states to use for both UL and DL communications).

The indication of the candidate TCI states may be associated with communicating with one or more base station and/or one or more TRPs associated with a single base station (e.g., the base station of FIG. 4).

As shown by reference number 420, the UE may store configurations of the candidate TCI states indicated in connection with reference number 415. For example, the UE may store one or more transmission or reception parameters associated with the candidate TCI states. The UE may associate the one or more transmission or reception parameters with TCI state identifications that may be indicated in a subsequent communication to activate and/or select one or more of the TCI state identifications.

As shown by reference number 425, the UE may receive, and the base station may transmit, an indication of a set of serving cells to have common candidate TCI states. For example, the base station may configure one or more serving cells to use a same candidate TCI state or a same set of candidate TCI states. In this way, a single indication of a subset of the candidate TCI states may indicate activation, deactivation, and/or updating of TCI states for all of the one or more serving cells.

As shown by reference number 430, the base station may identify an incorrect TCI state configuration for one or more serving cells of the set of serving cells indicated in connection with reference number 425. For example, the base station may determine and/or receive an indication that the one or more serving cells are abnormal and/or incorrectly configured serving cells from the set of serving cells.

As shown by reference number 435, the UE may receive, and the base station may transmit, an indication to remove at least one serving cell from the set of serving cells. For example, the UE may receive the indication to remove at least one serving cell that has an incorrect TCI state configuration, according to the identification by the base station described in connection with reference number 430. The base station may transmit the indication to remove the at least one serving cell via RRC signaling before sending the indication described in connection with reference number 440 (e.g. a MAC CE) to the UE.

As shown by reference number 440, the UE may receive, and the base station may transmit, an indication of a subset of the candidate TCI states for selection, including an indication of whether one or more candidate TCI states of the subset are joint uplink/downlink candidate TCI states. In some aspects, the UE may receive the indication of the subset within MAC CE signaling and/or via a control message. For example, the indication of the subset may be associated with a subsequent selection for a communication with the one or more base stations.

In some aspects, the indication of the subset may be included in a control message (e.g., MAC CE signaling) that includes multiple fields to indicate the subset. For example, the control message may include a first field of the control message may indicate activation of one or more candidate TCI states that are joint uplink/downlink candidate TCI states, a second field for indicating activation of one or more candidate TCI states that are uplink only candidate TCI states or downlink only candidate TCI states, and/or one or more fields for TCI state identifications associated with one or more activated candidate TCI states, among other examples. In some aspects, the control message may include an indication of whether all candidate TCI states identified in the control message are joint uplink/downlink candidate TCI states or separate uplink only candidate TCI states or downlink only candidate TCI states, an indication of whether one or more previously configured candidate TCI states are updated via the control message, an indication of an update to the one or more previously configured candidate TCI states, and/or an indication of a type of TCI state that is indicated in the subset of the candidate TCI states, among other examples. In some aspects, the first field and/or the second field comprise a bitmap associated with the one or more fields for the TCI state identifications that are associated with the one or more activated candidate TCI states.

In some aspects, the UE may ignore (e.g., not attempt to fully demodulate and/or decode) a first bit of the second field based at least in part on a first bit of the first field indicating activation of a candidate TCI state that is a joint uplink/downlink candidate TCI state. In some aspects, the first bit of the second field may indicate, based at least in part on the first bit of the first field not indicating activation of the candidate TCI state that is the joint uplink/downlink candidate TCI state, whether one or more associated fields of the one or more fields indicate a candidate TCI state for an uplink only TCI state, for a downlink only TCI state, or for an uplink only TCI state and a downlink only TCI state. In some aspects, the control message includes a content indication field that indicates whether the control message includes an indication of an additional TCI state to use for another of an uplink only TCI state or a downlink only TCI state (e.g., an link in an opposite direction (e.g., UL or DL) from a previous field).

In some aspects, the control message may not include the second field based at least in part on a configuration to activate or deactivate downlink only TCI states and uplink only TCI states together.

In some aspects, the control message includes a third field for indicating whether candidate TCI states indicated in the first field or the second field are activated or deactivated. For example, the third field may indicate that all candidate TCI states of the control message are activated or deactivated.

In some aspects, the control message may include a TCI type field (e.g., in a header or subheader of the control message and/or a header or subheader of the MAC CE, among other examples) to indicate which type of TCI state is to be activated or deactivated in the control message. For example, the TCI type field may indicate whether indicated candidate TCI states indicated in the control message are DL only, UL only, or joint UL/DL TCI states.

In some aspects, the UE may be configured for multiple TRP communication with the one or more base stations. The control message may include a first TCI state identification for a first joint uplink/downlink TCI state associated with a first TRP and a second TCI state identification for a second joint uplink/downlink TCI state associated with a second TRP, or one or more of a third TCI state identification for an uplink only TCI state, a downlink only TCI state, or both downlink only and uplink only TCI states for the first TRP or the second TRP, among other examples.

In some aspects, the subset of the candidate TCI states includes a single candidate TCI state. In this case, the UE may select the single candidate TCI state for the communication based at least in part on the subset of the candidate TCI states comprising the single candidate TCI state. For example, the UE may use a single active candidate TCI state for the communication without a subsequent DCI or other communication to indicate selection of the single active candidate TCI state.

In some aspects, the indication of the subset of the candidate TCI states applies to all serving cells configured in a set of serving cells having common candidate TCI states, as indicated in connection with reference numbers 425 and/or 435. For example, the UE may apply the indication of the subset of the candidate TCI states to all serving cells configured in the set of serving cells based at least in part on the indication of the subset of the candidate TCI states indicating a cell identification, and the cell identification being indicated in the set of serving cells (e.g., in connection with reference number 425). In some aspects, the base station or another network device may ensure that corresponding TCI states, (e.g.,. unified TCI states, DL only TCI states, and/or UL only TCI states) are configured correctly in each serving cell in the cell list (e.g., using RRC signaling).

As shown by reference number 445, the UE may receive a control message that indicates one or more candidate TCI states that are updated and an update to the one or more candidate TCI states. In some aspects, the control message may include the indication of the subset described in connection with reference number 440. In some aspects, the control message may be subsequent to the indication of the subset described in connection with reference number 440. In some aspects, the control message may include MAC CE signaling.

As shown by reference number 450, the UE may receive, and the base station may transmit, and indication of a candidate TCI state to use for a communication. For example, the UE may receive, in a communication subsequent to receiving the indication of the subset of the candidate TCI states described in connection with reference number 440, an indication of a candidate TCI state of the subset of the candidate TCI states for the communication.

As shown by reference number 455, the UE may configure the candidate TCI state. For example, the UE may configure one or more transmit and/or receive parameters associated with the candidate TCI state.

As shown by reference number 460, the UE and the base station may communicate using the candidate TCI state. In some aspects, the UE may use the candidate TCI state for a configured number of communications, for a configuration amount of time, and/or until receiving a subsequent indication of a candidate TIC state to use for a subsequent communication.

Based at least in part on the UE and the base station using one or more of the indications described in connection with FIG. 4, the UE and the base station may reduce an amount of bits used in the indication of the subset. In this way, the UE and the base station may conserve processing, network, communication, and power resources for the indication of the subset of the candidate TCI states (e.g., a MAC CE message or other control message) that may otherwise be used to support individual fields for each TCI state pool and/or for each TCI state type.

As indicated above, FIG. 4 is provided as an example. Other examples may differ from what is described with regard to FIG. 4.

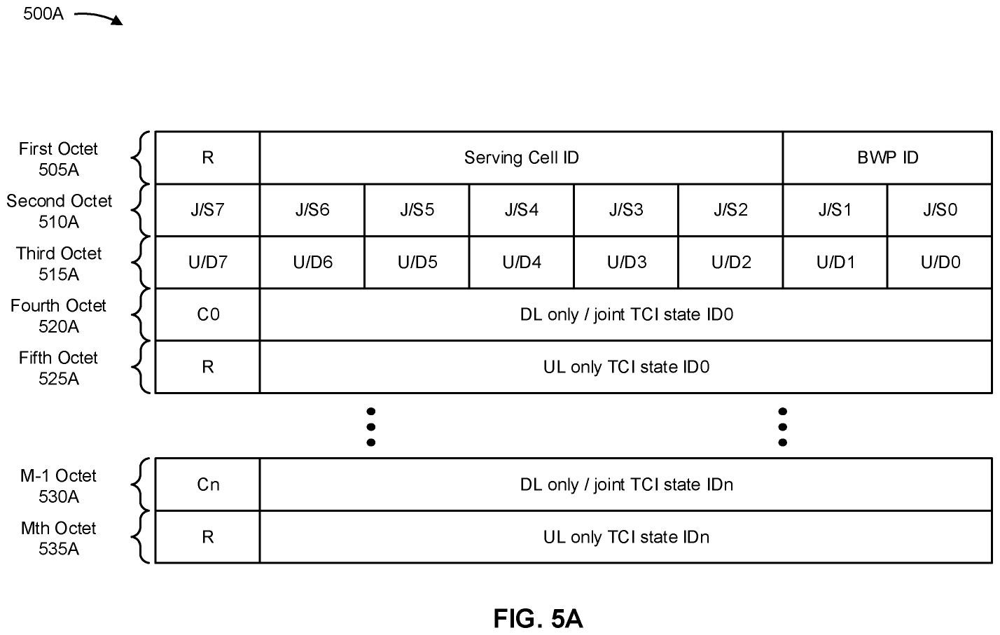

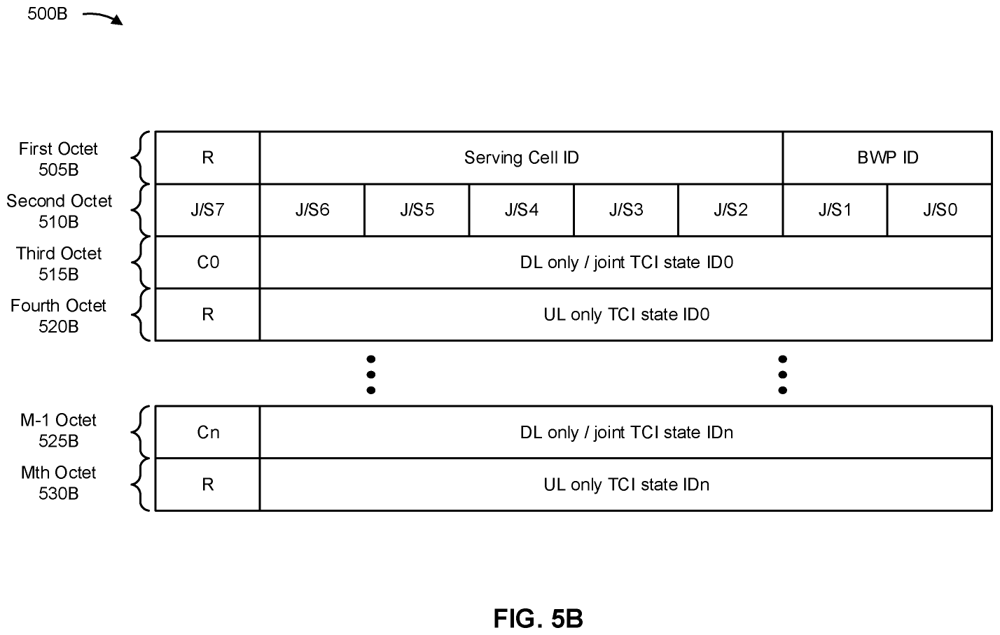

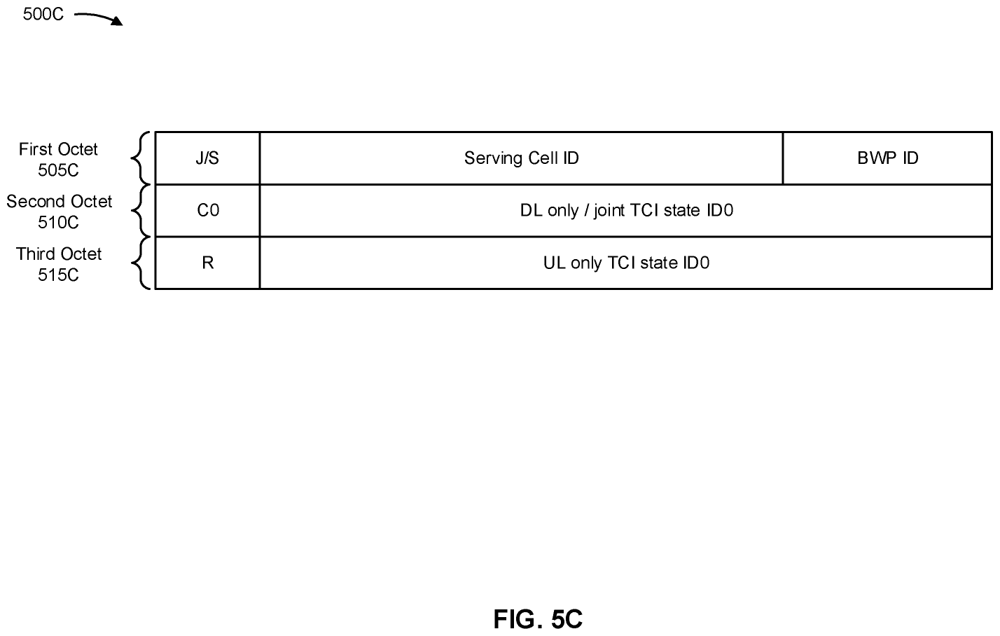

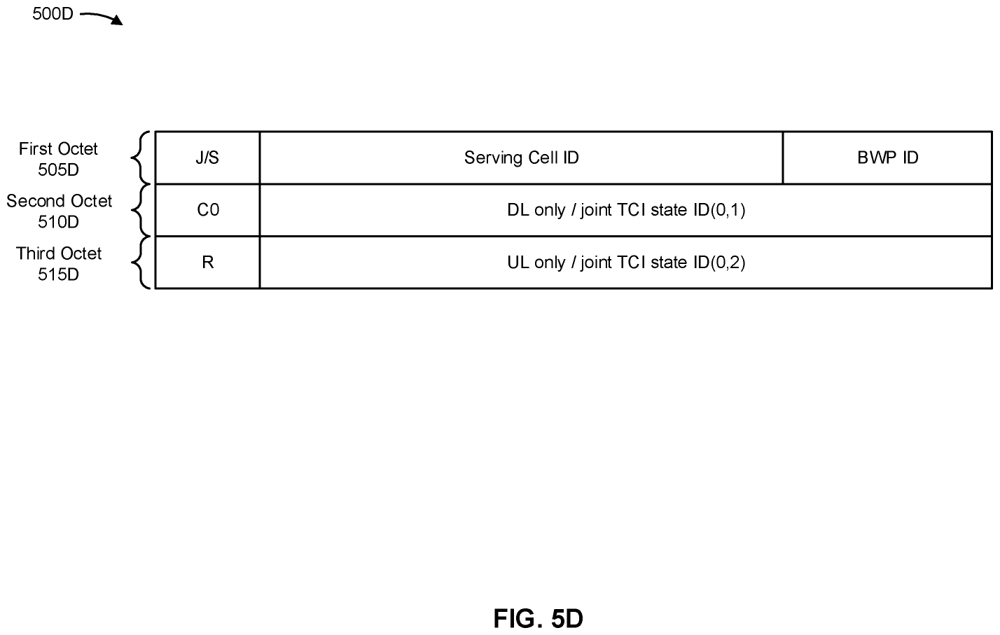

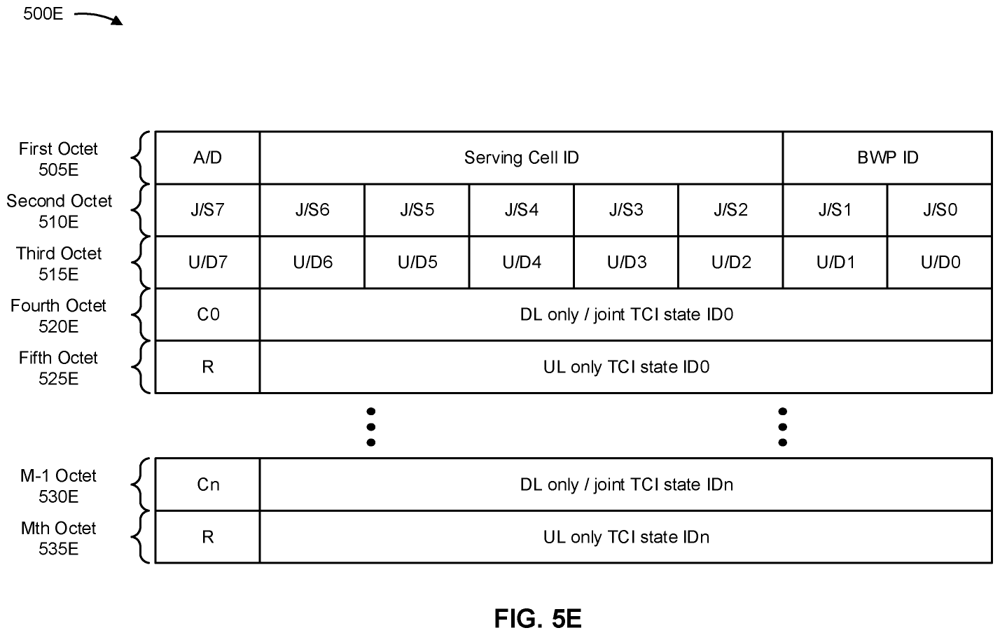

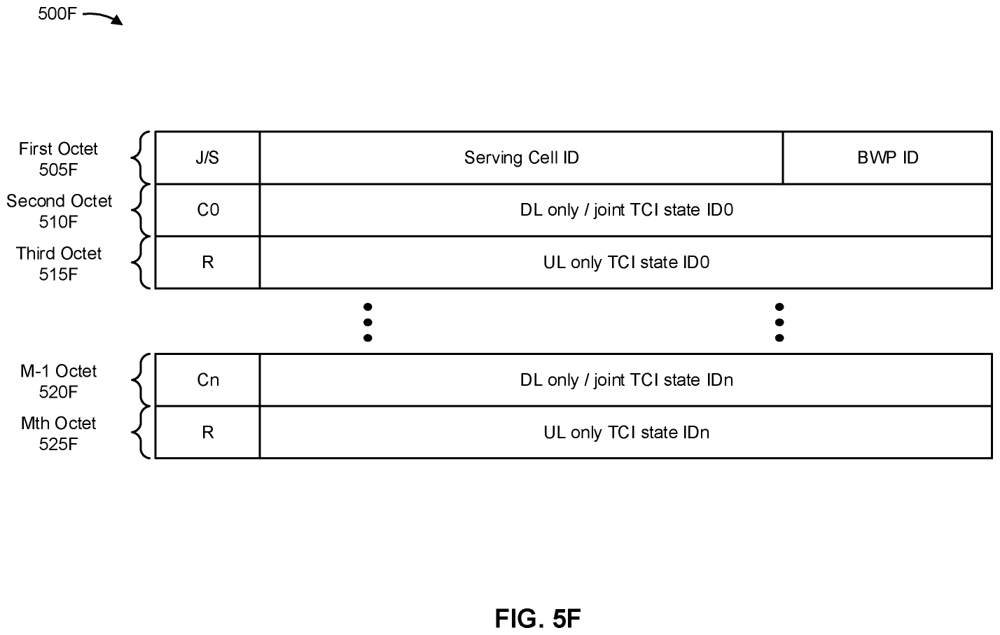

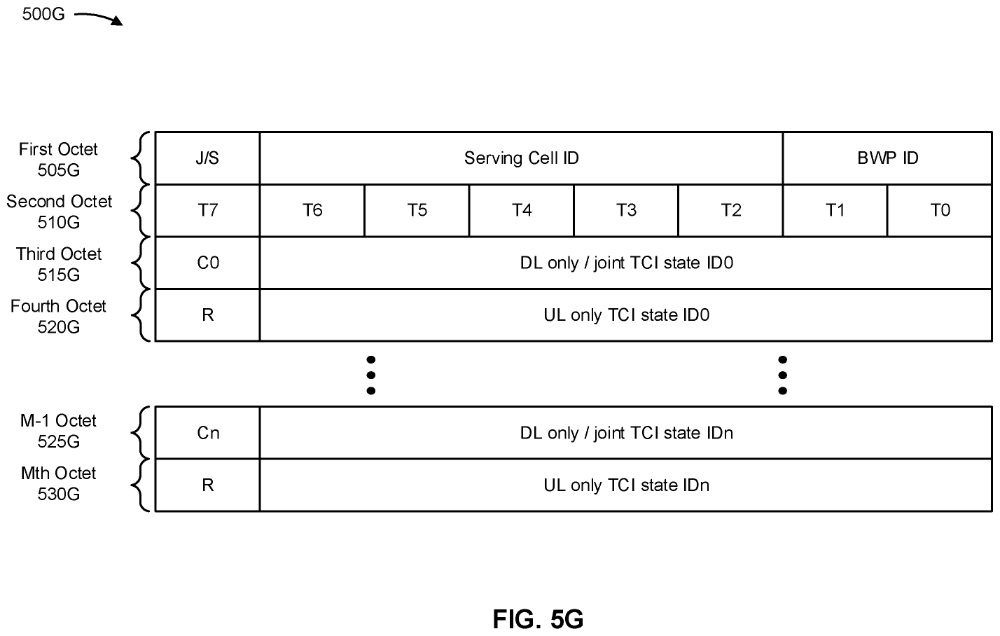

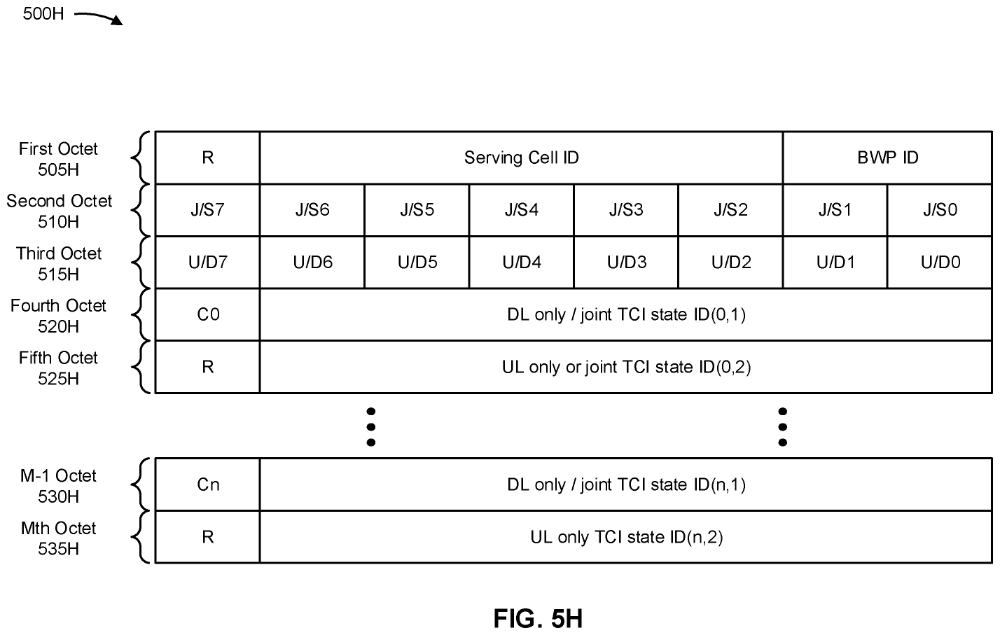

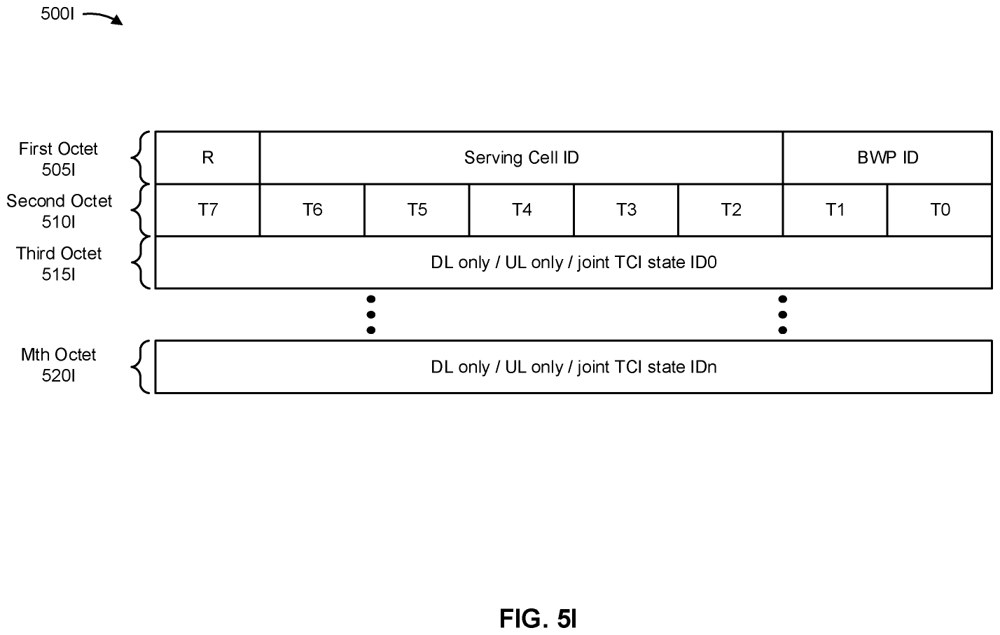

FIG. 5A is a diagram illustrating an example 500A associated with a control message associated with configuring candidate transmission configuration indicator states, in accordance with the present disclosure. The control message may include, or may be included in, MAC CE signaling.

As shown in FIG. 5A, the control message includes a first octet 505A that includes a reserve field (e.g., 1 bit), a serving cell identification (ID) field (e.g., 5 bits), and a bandwidth part (BWP) ID field (e.g., 2 bits).

The control message includes a second octet 510A that includes fields to indicate activation or deactivation of either a joint DL/UL TCI state (e.g., set to 1) or separate DL/UL TCI state (e.g., set to 0). In some aspects, based at least in part on J/S(i) being set to 1, a corresponding U/D(i) field of a third octet 515A may be ignored, and a corresponding joint TCI state ID(i) should be present in the control message. In some aspects, based at least in part on the J/S (i) being set to 0, the corresponding U/D (i) field should be checked. It is optional whether an associated UL only TCI state is present or not, which may depend on a C field of the fourth octet 520A, or M−1 octet 530A.

The U/D fields of the third octet 515A may indicate whether DL only or UL only or DL only+UL only TCI states in corresponding octets are activated or not (e.g., the corresponding J/S is set to 0 so the U/D field is checked). For each TCI codepoint, the network (e.g., the base station 110) may indicate a DL only TCI state, a UL only TCI state, or both DL and UL TCI state by using a combination of U/D(i) and C(i) fields. For example, if U/D (i) is set to 1, a DL only state is present, and C(i) indicates whether a UL only TCI state is present or not in a following octet. If U/D(i) is set to 0, only UL only TCI state is present.

The bits of J/S and U/D fields may map (e.g., according to a bitmap) to a TCI codepoint in a subsequent DCI message. In some aspects, the TCI state update is in the same order of the bit it in the bitmap.

In some aspects, the control message described in connection with FIG. 5A may be used based at least in part on DL only and joint DL/UL candidate TCI states sharing a pool and UL only candidate TCI states being separated in a different pool. In this case, the base station may configure the DL only candidate TCI states, which share a same ID space as joint DL/UL TCI state. One index may indicate both the DL only TCI state and joint DL/UL TCI state.

Subsequent octets (e.g., the fourth octet 520A, a fifth octet 525A, an M−1 octet 530A, and/or an Mth octet 535A, among other examples) may provide information to identify the TCI states and associated parameters previously configured in an associated candidate TCI pool.

In some aspects where DL only and UL only share a TCI state pool with joint DL/UL TCI states, a TCI ID space of joint DL/UL TCI states may be shared with DL only TCI states and UL only TCI states. One index may represent a joint DL/UL TCI state, a DL only TCI state, and a UL only TCI state. In this case, the control message may indicate which type of TCI state is activated/deactivated for each TCI field codepoint. In an example of associated J/S, U/D, and C fields, the control message may indicate a type of TCI state indicated. For example, a set of (1,x,0) may indicate a joint DL/UL TCI state, a set of (1,x,1) may indicate a joint DL/UL TCI state and a UL only TCI state, a set of (0,1,0) may indicate a DL only TCI state, a set of (0,1,1) may indicate a DL only TCI state and a UL only TCI state, and a set of (0,0,0) may indicate a UL only TCI state.

As indicated above, FIG. 5A is provided as an example. Other examples may differ from what is described with regard to FIG. 5A.

FIG. 5B is a diagram illustrating an example 500B associated with a control message associated with configuring candidate transmission configuration indicator states, in accordance with the present disclosure. The control message may include, or may be included in, MAC CE signaling. FIG. 5B includes multiple fields previously described in connection with FIG. 5A, which fields may include information as described in connection with FIG. 5A.

As shown in FIG. 5B, the control message includes a first octet 505B that includes a reserve field (e.g., 1 bit), a serving cell ID field (e.g., 5 bits), and a BWP ID field (e.g., 2 bits).

As shown in FIG. 5B, the control message may include a second octet 510B that includes fields to indicate activation or deactivation of either a joint DL/UL TCI state (e.g., set to 1) or separate DL/UL TCI state (e.g., set to 0) and may not include the fields to indicate whether DL only or UL only or DL only+UL only TCI states in corresponding octets are activated or not (e.g., the third octet 515A of FIG. 5A). For example, based at least in part on a configuration that separate DL only and UL only TCI state are always activated or deactivated together, the U/D octet may be removed to reduce one-byte of overhead in the control message. In this option, UL only TCI activation or deactivation only may not be supported. In an example, if J/S(i) is set to 1, the UE may respond the same as in FIG. 5A. If J/S(i) is set to 0, a DL only state is present, and C (i) indicates whether UL only TCI state is present in the following octet.

Subsequent octets (e.g., a third octet 515B, a fourth octet 520B, an M−1 octet 525B, and/or an Mth octet 530B, among other examples) may provide information to identify the TCI states and associated parameters previously configured in an associated candidate TCI pool.

As indicated above, FIG. 5B is provided as an example. Other examples may differ from what is described with regard to FIG. 5B.

FIG. 5C is a diagram illustrating an example 500C associated with a control message associated with configuring candidate transmission configuration indicator states, in accordance with the present disclosure. The control message may include, or may be included in, MAC CE signaling. FIG. 5C includes multiple fields previously described in connection with FIG. 5A, which fields may include information as described in connection with FIG. 5A.

As shown in FIG. 5C, a first octet 505C may include a field for indicating whether a subsequent indication of TCI states indicate a joint DL/UL TCI state (e.g., set to 1) or separate DL/UL TCI state (e.g., set to 0). In this way, the control message may activate one TCI state, with the activated TCI state being implicitly selected via the control message without further DCI indication. The J/S field of the first octet 505C indicates either a joint TCI state (e.g., set to 1) or a separate DL/UL TCI state (e.g., set to 0). It is optional whether an associated UL only TCI state is present or not. For example, the C field in the first bit of the second octet 510C may indicate whether the UL only TCI state is present in a third octet 515C.

As indicated above, FIG. 5C is provided as an example. Other examples may differ from what is described with regard to FIG. 5C.

FIG. 5D is a diagram illustrating an example 500D associated with a control message associated with configuring candidate transmission configuration indicator states, in accordance with the present disclosure. The control message may include, or may be included in, MAC CE signaling. FIG. 5D includes multiple fields previously described in connection with FIG. 5A or 5C, which fields may include information as described in connection with FIG. 5A or 5C.

As shown in FIG. 5D, a first octet 505D may include a field for indicating whether a subsequent indication of TCI states indicate a joint DL/UL TCI state (e.g., set to 1) or separate DL/UL TCI state (e.g., set to 0). In this way, the control message may activate one TCI state, with the activated TCI state being implicitly selected via the control message without further DCI indication. The J/S field of the first octet 505D indicates either a joint TCI state (e.g., set to 1) or a separate DL/UL TCI state (e.g., set to 0). It is optional whether an associated UL only TCI state is present or not. For example, the C field in the first bit of a second octet 510D may indicate whether the UL only TCI state is present in a third octet 515D. In some aspects, the DL only or joint TCI state field of the second octet 510D may indicate a set of joint TCI states associated with a multi-TRP configuration (e.g., configuration (0,1), the first TRP) and/or the UL only or joint TCI state field of the third octet 515D may indicate a set of joint TCI states associated with a multi-TRP configuration (e.g., configuration (0,2), the second TRP).

As indicated above, FIG. 5D is provided as an example. Other examples may differ from what is described with regard to FIG. 5D.

FIG. 5E is a diagram illustrating an example 500E associated with a control message associated with configuring candidate transmission configuration indicator states, in accordance with the present disclosure. The control message may include, or may be included in, MAC CE signaling. FIG. 5E includes multiple fields previously described in connection with FIG. 5A, which fields may include information as described in connection with FIG. 5A.

As shown in FIG. 5E, the control message may include a bit in a first octet 505E that indicates whether the control message is used to activate or deactivate TCI states indicated within the control message.

A second octet 510E includes fields to indicate either a joint DL/UL TCI state (e.g., set to 1) or separate DL/UL TCI state (e.g., set to 0). A third octet 515E may include fields to indicate whether DL only or UL only or DL only+UL only TCI states in corresponding octets are activated. Subsequent octets (e.g., a fourth octet 520E, a fifth octet 525E, an M−1 octet 530E, and/or an Mth octet 535E, among other examples) may provide information to identify the TCI states and associated parameters previously configured in an associated candidate TCI pool.

As indicated above, FIG. 5E is provided as an example. Other examples may differ from what is described with regard to FIG. 5E.

FIG. 5F is a diagram illustrating an example 500F associated with a control message associated with configuring candidate transmission configuration indicator states, in accordance with the present disclosure. The control message may include, or may be included in, MAC CE signaling. FIG. 5F includes multiple fields previously described in connection with FIG. 5A, which fields may include information as described in connection with FIG. 5A.

As shown in FIG. 5F, the control message may include a first octet 505F that includes a field for indicating whether a subsequent indication of TCI states indicate a joint DL/UL TCI state (e.g., set to 1) or separate DL/UL TCI state (e.g., set to 0). For example, if the J/S is set to 1, all the “UL only TCI state ID” fields may not be present in the control message. Joint TCI states may be activated for each TCI field codepoint. If the J/S is set to 0, a C(i) field determines whether a UL only TCI state is present at a third octet 515F or not after a second octet 510F.

Subsequent octets (e.g., an M−1 octet 520F, and/or an Mth octet 525F, among other examples) may provide information to identify the TCI states and associated parameters previously configured in an associated candidate TCI pool.

As indicated above, FIG. 5F is provided as an example. Other examples may differ from what is described with regard to FIG. 5F.

FIG. 5G is a diagram illustrating an example 500G associated with a control message associated with configuring candidate transmission configuration indicator states, in accordance with the present disclosure. The control message may include, or may be included in, MAC CE signaling. FIG. 5G includes multiple fields previously described in connection with FIG. 5A, which fields may include information as described in connection with FIG. 5A.

As shown in FIG. 5G, the control message may include a first octet 505G that includes field for indicating whether a subsequent indication of TCI states indicate a joint DL/UL TCI state (e.g., set to 1) or separate DL/UL TCI state (e.g., set to 0). For example, if the J/S is set to 1, all the “UL only TCI state ID” fields may not be present in the control message. Joint TCI states may be activated for each TCI field codepoint. If the J/S is set to 0, a C(i) field determines whether a UL only TCI state is present at a fourth octet 520G or not after the third octet 515G.

A second octet 510G includes fields to indicate which TCI field codepoints are selected to be updated with an activated joint DL/UL TCI state or separate DL only and UL only TCI state, with T fields that represent the TCI field codepoint. If T(i) is set to 1, a corresponding TCI field codepoint is updated with an activated joint DL/UL TCI state or separate DL only and UL only TCI state. If T(i) is 0, no update on the corresponding TCI field codepoint or the original TCI state is deactivated.

Subsequent octets (e.g., an M−1 octet 525G, and/or an Mth octet 530G, among other examples) may provide information to identify the TCI states and associated parameters previously configured in an associated candidate TCI pool.

As indicated above, FIG. 5G is provided as an example. Other examples may differ from what is described with regard to FIG. 5G.

FIG. 5H is a diagram illustrating an example 500H associated with a control message associated with configuring candidate transmission configuration indicator states, in accordance with the present disclosure. The control message may include, or may be included in, MAC CE signaling. FIG. 5H includes multiple fields previously described in connection with FIG. 5A, which fields may include information as described in connection with FIG. 5A.

A first octet 505H may include a reserve field, a serving cell ID field and a BWP ID field, as described in connection with FIG. 5A. The control message includes a second octet 510H that includes fields to indicate activation or deactivation of either a joint DL/UL TCI state (e.g., set to 1) or separate DL/UL TCI state (e.g., set to 0). U/D fields of a third octet 515H may indicate whether DL only or UL only or DL only+UL only TCI states in corresponding octets are activated or not (e.g., the corresponding J/S is set to 0 so the U/D field is checked), as described in connection with FIG. 5A.

Based at least in part on multi-TRP communication being configured, each TCI field codepoint in a DCI may correspond to 1 or 2 TCI states. For joint DL/UL TCI state activation, if J/S (i) is set to 1, two corresponding joint DL/UL TCI state (ID(0,1) and ID(0,2)) are activated/deactivated for the corresponding TRP in the control message. If J/S(i) is set to 0, one TRP may be updated with a DL-only and/or UL-only TCI state. In this case, the U/D fields may be reused to indicate a TRP index.

A fourth octet 520H may include an indication of a DL only or joint TCI state ID(0,1) and a fifth octet 525H may include an indication of a UL only or joint TCI state ID(0,2). Subsequent octets (e.g., an M−1 octet 530H, and/or an Mth octet 535H, among other examples) may provide information to identify the TCI states and associated parameters previously configured in an associated candidate TCI pool.

As indicated above, FIG. 5H is provided as an example. Other examples may differ from what is described with regard to FIG. 5H.

FIG. 5I is a diagram illustrating an example 500I associated with a control message associated with configuring candidate transmission configuration indicator states, in accordance with the present disclosure. The control message may include, or may be included in, MAC CE signaling. FIG. 5I includes multiple fields previously described in connection with FIG. 5A, which fields may include information as described in connection with FIG. 5A.

As shown in FIG. 5I, the control message may include a first octet 505I field that includes a reserve bit, a serving cell ID field, and a BWP ID field, as described in connection with FIG. 5A.

A second octet 510I includes fields to indicate which TCI field codepoints are selected to be updated with an activated joint DL/UL TCI state or separate DL only and UL only TCI state, with T fields that represent the TCI field codepoint. If T(i) is set to 1, a corresponding TCI field codepoint is updated with an activated joint DL/UL TCI state or separate DL only and UL only TCI state. If T(i) is 0, no update on the corresponding TCI field codepoint or the original TCI state is deactivated.

Subsequent octets (e.g., a third octet 515I, and/or an Mth octet 520I, among other examples) may provide information to identify the TCI states and associated parameters previously configured in an associated candidate TCI pool.

In some aspects, the control message of FIG. 5I and/or other control messages described herein may include a TCI type field (e.g., in a header or subheader of the control message (e.g., the first octet 505I or the second octet 510I) and/or a header or subheader of the MAC CE, among other examples) to indicate which type of TCI state is to be activated or deactivated in the control message. For example, the TCI type field may indicate whether indicated candidate TCI states indicated in the control message are DL only, UL only, or joint UL/DL TCI states.

The control message of FIG. 5I may be used based at least in part on a configuration of different ID spaces, lists, or pools for different types of TCI states. The control message indicates which TCI field codepoint is selected to be updated by T field. Only one type of TCI state is activated or deactivated, (e.g., DL only, UL only, or joint TCI state ID).

As indicated above, FIG. 5I is provided as an example. Other examples may differ from what is described with regard to FIG. 5I.

FIG. 6 is a diagram illustrating an example process 600 performed, for example, by a UE, in accordance with the present disclosure. Example process 600 is an example where the UE (e.g., UE 120) performs operations associated with configuring candidate TCI states.

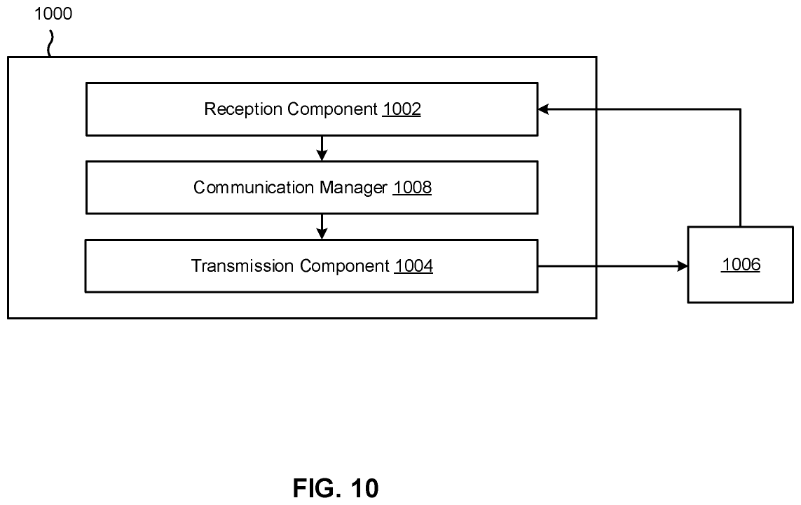

As shown in FIG. 6, in some aspects, process 600 may include receiving an indication of candidate TCI states for communicating with one or more base stations (block 610). For example, the UE (e.g., using communication manager 140 and/or reception component 1002, depicted in FIG. 10) may receive an indication of candidate TCI states for communicating with one or more base stations, as described above.

As further shown in FIG. 6, in some aspects, process 600 may include receiving an indication of a subset of the candidate TCI states for selection for a communication with the one or more base stations, the indication of the subset including an indication of whether one or more candidate TCI states of the subset of the candidate TCI states are joint uplink/downlink candidate TCI states (block 620). For example, the UE (e.g., using communication manager 140 and/or reception component 1002, depicted in FIG. 10) may receive an indication of a subset of the candidate TCI states for selection for a communication with the one or more base stations, the indication of the subset including an indication of whether one or more candidate TCI states of the subset of the candidate TCI states are joint uplink/downlink candidate TCI states, as described above.

Process 600 may include additional aspects, such as any single aspect or any combination of aspects described below and/or in connection with one or more other processes described elsewhere herein.

In a first aspect, receiving the indication of the candidate TCI states comprises receiving the indication of the candidate TCI states via RRC signaling.

In a second aspect, alone or in combination with the first aspect, receiving the indication of the subset of the candidate TCI states comprises receiving the indication of the subset of the candidate TCI states via MAC CE signaling.

In a third aspect, alone or in combination with one or more of the first and second aspects, receiving the indication of the subset of the candidate TCI states comprises receiving the indication of the subset of the candidate TCI states via a control message, the control message comprising one or more of a first field for indicating activation of one or more candidate TCI states that are joint uplink/downlink candidate TCI states, a second field for indicating activation of one or more candidate TCI states that are uplink only candidate TCI states or downlink only candidate TCI states, one or more fields for TCI state identifications associated with one or more activated candidate TCI states, an indication of whether all candidate TCI states identified in the control message are joint uplink/downlink candidate TCI states or separate uplink only candidate TCI states or downlink only candidate TCI states, an indication of whether one or more previously configured candidate TCI states are updated via the control message, an indication of an update to the one or more previously configured candidate TCI states, or an indication of a type of TCI state that is indicated in the subset of the candidate TCI states.

In a fourth aspect, alone or in combination with one or more of the first through third aspects, one or more of the first field or the second field comprise a bitmap associated with the one or more fields for the TCI state identifications that are associated with the one or more activated candidate TCI states.

In a fifth aspect, alone or in combination with one or more of the first through fourth aspects, a first bit of the second field is ignored based at least in part on a first bit of the first field indicating activation of a candidate TCI state that is a joint uplink/downlink candidate TCI state, or wherein the first bit of the second field indicates, based at least in part on the first bit of the first field not indicating activation of the candidate TCI state that is the joint uplink/downlink candidate TCI state, whether one or more associated fields of the one or more fields indicate a candidate TCI state for an uplink only TCI state, for a downlink only TCI state, or for an uplink only TCI state and a downlink only TCI state.

In a sixth aspect, alone or in combination with one or more of the first through fifth aspects, the control message comprises a content indication field that indicates whether the control message includes an indication of an additional TCI state to use for another of an uplink only TCI state or a downlink only TCI state.

In a seventh aspect, alone or in combination with one or more of the first through sixth aspects, the control message does not include the second field based at least in part on a configuration to activate or deactivate downlink only TCI states and uplink only TCI states together.

In an eighth aspect, alone or in combination with one or more of the first through seventh aspects, the control message comprises a third field for indicating whether candidate TCI states indicated in the first field or the second field are activated or deactivated.

In a ninth aspect, alone or in combination with one or more of the first through eighth aspects, the UE is configured for multiple TRP communication with the one or more base stations, and wherein the control message comprises a first TCI state identification for a first joint uplink/downlink TCI state associated with a first TRP and a second TCI state identification for a second joint uplink/downlink TCI state associated with a second TRP, or one or more of a third TCI state identification for an uplink only TCI state, a downlink only TCI state, or both downlink only and uplink only TCI states for the first TRP or the second TRP.

In a tenth aspect, alone or in combination with one or more of the first through ninth aspects, the subset of the candidate TCI states comprises a single candidate TCI state, and wherein the method further comprises selecting the single candidate TCI state for the communication with the one or more base stations based at least in part on the subset of the candidate TCI states comprising the single candidate TCI state.

In an eleventh aspect, alone or in combination with one or more of the first through tenth aspects, process 600 includes receiving, in a communication subsequent to receiving the indication of the subset of the candidate TCI states, an indication of a candidate TCI state of the subset of the candidate TCI states for the communication.

In a twelfth aspect, alone or in combination with one or more of the first through eleventh aspects, the indication of the subset of the candidate TCI states applies to all serving cells configured in a set of serving cells having common candidate TCI states.

In a thirteenth aspect, alone or in combination with one or more of the first through twelfth aspects, the indication of the subset of the candidate TCI states applies to all serving cells configured in the set of serving cells based at least in part on the indication of the subset of the candidate TCI states indicating a cell identification, and the cell identification being indicated in the set of serving cells via a configuration message.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a base station, in accordance with the present disclosure. Example process 700 is an example where the base station (e.g., base station 110) performs operations associated with configuring candidate TCI states.

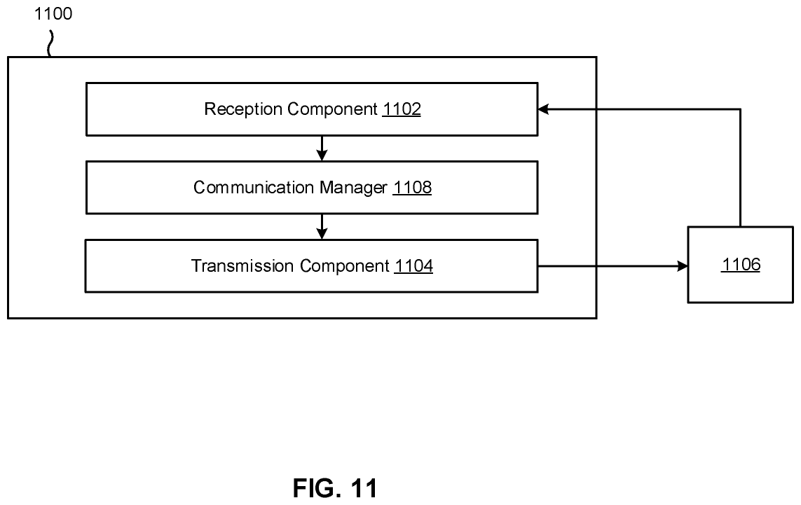

As shown in FIG. 7, in some aspects, process 700 may include transmitting an indication of candidate TCI states for communicating with one or more base stations (block 710). For example, the base station (e.g., using communication manager 150 and/or transmission component 1104, depicted in FIG. 11) may transmit an indication of candidate TCI states for communicating with one or more base stations, as described above.

As further shown in FIG. 7, in some aspects, process 700 may include transmitting an indication of a subset of the candidate TCI states for selection for a communication with the one or more base stations, the indication of the subset including an indication of whether one or more candidate TCI states of the subset of the candidate TCI states are joint uplink/downlink candidate TCI states (block 720). For example, the base station (e.g., using communication manager 150 and/or transmission component 1104, depicted in FIG. 11) may transmit an indication of a subset of the candidate TCI states for selection for a communication with the one or more base stations, the indication of the subset including an indication of whether one or more candidate TCI states of the subset of the candidate TCI states are joint uplink/downlink candidate TCI states, as described above.

Process 700 may include additional aspects, such as any single aspect or any combination of aspects described below and/or in connection with one or more other processes described elsewhere herein.

In a first aspect, transmitting the indication of the candidate TCI states comprises transmitting the indication of the candidate TCI states via RRC signaling.

In a second aspect, alone or in combination with the first aspect, transmitting the indication of the subset of the candidate TCI states comprises transmitting the indication of the subset of the candidate TCI states via MAC CE signaling.

In a third aspect, alone or in combination with one or more of the first and second aspects, transmitting the indication of the subset of the candidate TCI states comprises transmitting the indication of the subset of the candidate TCI states via a control message, the control message comprising one or more of a first field for indicating activation of one or more candidate TCI states that are joint uplink/downlink candidate TCI states, a second field for indicating activation of one or more candidate TCI states that are uplink only candidate TCI states or downlink only candidate TCI states, one or more fields for TCI state identifications associated with one or more activated candidate TCI states, an indication of whether all candidate TCI states identified in the control message are joint uplink/downlink candidate TCI states or separate uplink only candidate TCI states or downlink only candidate TCI states, an indication of whether one or more previously configured candidate TCI states are updated via the control message, an indication of an update to the one or more previously configured candidate TCI states, or an indication of a type of TCI state that is indicated in the subset of the candidate TCI states.

In a fourth aspect, alone or in combination with one or more of the first through third aspects, one or more of the first field or the second field comprise a bitmap associated with the one or more fields for the TCI state identifications that are associated with the one or more activated candidate TCI states.

In a fifth aspect, alone or in combination with one or more of the first through fourth aspects, a first bit of the second field is ignored based at least in part on a first bit of the first field indicating activation of a candidate TCI state that is a joint uplink/downlink candidate TCI state, or wherein the first bit of the second field indicates, based at least in part on the first bit of the first field not indicating activation of the candidate TCI state that is the joint uplink/downlink candidate TCI state, whether one or more associated fields of the one or more fields indicate a candidate TCI state for an uplink only TCI state, for a downlink only TCI state, or for an uplink only TCI state and a downlink only TCI state.

In a sixth aspect, alone or in combination with one or more of the first through fifth aspects, the control message comprises a content indication field that indicates whether the control message includes an indication of an additional TCI state to use for another of an uplink only TCI state or a downlink only TCI state.

In a seventh aspect, alone or in combination with one or more of the first through sixth aspects, the control message does not include the second field based at least in part on a configuration to activate or deactivate downlink only TCI states and uplink only TCI states together.

In an eighth aspect, alone or in combination with one or more of the first through seventh aspects, the control message comprises a third field for indicating whether candidate TCI states indicated in the first field or the second field are activated or deactivated.

In a ninth aspect, alone or in combination with one or more of the first through eighth aspects, the UE is configured for multiple TRP communication with the base station, and wherein the control message comprises a first TCI state identification for a first joint uplink/downlink TCI state associated with a first TRP and a second TCI state identification for a second joint uplink/downlink TCI state associated with a second TRP, or one or more of a third TCI state identification for an uplink only TCI state, a downlink only TCI state, or both downlink only and uplink only TCI states for the first TRP or the second TRP.

In a tenth aspect, alone or in combination with one or more of the first through ninth aspects, the subset of the candidate TCI states comprises a single candidate TCI state, and wherein the subset of the candidate TCI states comprising the single candidate TCI states indicates that the UE is to select the single candidate TCI state for the communication with the base station.

In an eleventh aspect, alone or in combination with one or more of the first through tenth aspects, process 700 includes transmitting, in a communication subsequent to transmitting the indication of the subset of the candidate TCI states, an indication of a candidate TCI state of the subset of the candidate TCI states for the communication.

In a twelfth aspect, alone or in combination with one or more of the first through eleventh aspects, the indication of the subset of the candidate TCI states applies to all serving cells configured in a set of serving cells having common candidate TCI states.

In a thirteenth aspect, alone or in combination with one or more of the first through twelfth aspects, the indication of the subset of the candidate TCI states applies to all serving cells configured in the set of serving cells based at least in part on the indication of the subset of the candidate TCI states indicating a cell identification, and the cell identification being indicated in the set of serving cells via a configuration message.

In a fourteenth aspect, alone or in combination with one or more of the first through thirteenth aspects, process 700 includes transmitting an indication of a serving cell in the set of serving cells within the indication of the subset of the candidate TCI states, or transmitting, before transmitting the indication of the subset of the candidate TCI states, an indication to remove at least one serving cell from the set of serving cells.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by an UE, in accordance with the present disclosure. Example process 800 is an example where the UE (e.g., UE 120) performs operations associated with configuring candidate TCI states.

As shown in FIG. 8, in some aspects, process 800 may include receiving an indication of candidate TCI states for selection for a communication with one or more base stations (block 810). For example, the UE (e.g., using communication manager 140 and/or reception component 1002, depicted in FIG. 10) may receive an indication of candidate TCI states for selection for a communication with one or more base stations, as described above.

As further shown in FIG. 8, in some aspects, process 800 may include receiving a control message that indicates one or more of the candidate TCI states that are updated and that indicates an update to the one or more of the candidate TCI states (block 820). For example, the UE (e.g., using communication manager 140 and/or reception component 1002, depicted in FIG. 10) may receive a control message that indicates one or more of the candidate TCI states that are updated and that indicates an update to the one or more of the candidate TCI states, as described above.

Process 800 may include additional aspects, such as any single aspect or any combination of aspects described below and/or in connection with one or more other processes described elsewhere herein.

In a first aspect, receiving the indication of the candidate TCI states comprises receiving the indication of the candidate TCI states via RRC signaling.

In a second aspect, alone or in combination with the first aspect, receiving the control message comprises receiving the control message via MAC CE signaling.

In a third aspect, alone or in combination with one or more of the first and second aspects, process 800 includes receiving an indication of whether the one or more of the candidate TCI states that are updated include one or more of joint uplink/downlink candidate TCI states, downlink only candidate TCI states, uplink only candidate TCI states, or uplink only candidate TCI states and downlink only candidate TCI states.

In a fourth aspect, alone or in combination with one or more of the first through third aspects, the control message comprises one or more of a first field for indicating activation of one or more candidate TCI states that are joint uplink/downlink candidate TCI states, a second field for indicating activation of one or more candidate TCI states that are uplink only candidate TCI states or downlink only candidate TCI states, one or more fields for TCI state identifications associated with one or more activated candidate TCI states, an indication of whether all candidate TCI states identified in the control message are joint uplink/downlink candidate TCI states or separate uplink only candidate TCI states or downlink only candidate TCI states.

In a fifth aspect, alone or in combination with one or more of the first through fourth aspects, one or more of the first field or the second field comprise a bitmap associated with the one or more fields for the TCI state identifications that are associated with the one or more activated candidate TCI states.

In a sixth aspect, alone or in combination with one or more of the first through fifth aspects, a first bit of the second field is ignored based at least in part on a first bit of the first field indicating activation of a candidate TCI state that is a joint uplink/downlink candidate TCI state, or wherein the first bit of the second field indicates, based at least in part on the first bit of the first field not indicating activation of the candidate TCI state that is the joint uplink/downlink candidate TCI state, whether one or more associated fields of the one or more fields indicate a candidate TCI state for an uplink only TCI state, for a downlink only TCI state, or for an uplink only TCI state and a downlink only TCI state.

In a seventh aspect, alone or in combination with one or more of the first through sixth aspects, the control message does not include the second field based at least in part on a configuration to activate or deactivate downlink only TCI states and uplink only TCI states together.

In an eighth aspect, alone or in combination with one or more of the first through seventh aspects, the control message comprises a content indication field that indicates whether the control message includes an indication of a TCI state to use as a downlink only TCI state.

In a ninth aspect, alone or in combination with one or more of the first through eighth aspects, the UE is configured for multiple TRP communication with the one or more base stations, and wherein the control message comprises a first TCI state identification for a first joint uplink/downlink TCI state associated with a first TRP and a second TCI state identification for a second joint uplink/downlink TCI state associated with a second TRP, or one or more of a third TCI state identification for an uplink only TCI state, a downlink only TCI state, or both downlink only and uplink only TCI states for the first TRP or the second TRP.

In a tenth aspect, alone or in combination with one or more of the first through ninth aspects, process 800 includes receiving, in a communication subsequent to receiving the indication of the subset of the candidate TCI states, an indication of a candidate TCI state of the subset of the candidate TCI states for the communication.

In an eleventh aspect, alone or in combination with one or more of the first through tenth aspects, the control message applies to all serving cells configured in a set of serving cells having common candidate TCI states.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110) performs operations associated with configuring candidate TCI states.

As shown in FIG. 9, in some aspects, process 900 may include transmitting an indication of candidate TCI states for selection for a communication with one or more base stations (block 910). For example, the base station (e.g., using communication manager 150 and/or transmission component 1104, depicted in FIG. 11) may transmit an indication of candidate TCI states for selection for a communication with one or more base stations, as described above.

As further shown in FIG. 9, in some aspects, process 900 may include transmitting a control message that indicates one or more of the candidate TCI states that are updated and that indicates an update to the one or more of the candidate TCI states (block 920). For example, the base station (e.g., using communication manager 150 and/or transmission component 1104, depicted in FIG. 11) may transmit a control message that indicates one or more of the candidate TCI states that are updated and that indicates an update to the one or more of the candidate TCI states, as described above.

Process 900 may include additional aspects, such as any single aspect or any combination of aspects described below and/or in connection with one or more other processes described elsewhere herein.

In a first aspect, transmitting the indication of the candidate TCI states comprises transmitting the indication of the candidate TCI states via RRC signaling.

In a second aspect, alone or in combination with the first aspect, transmitting the control message comprises receiving the control message via MAC CE signaling.

In a third aspect, alone or in combination with one or more of the first and second aspects, process 900 includes transmitting an indication of whether the one or more of the candidate TCI states that are updated include one or more of joint uplink/downlink candidate TCI states, downlink only candidate TCI states, uplink only candidate TCI states, or uplink only candidate TCI states and downlink only candidate TCI states.

In a fourth aspect, alone or in combination with one or more of the first through third aspects, the control message comprises one or more of a first field for indicating activation of one or more candidate TCI states that are joint uplink/downlink candidate TCI states, a second field for indicating activation of one or more candidate TCI states that are uplink only candidate TCI states or downlink only candidate TCI states, one or more fields for TCI state identifications associated with one or more activated candidate TCI states, an indication of whether all candidate TCI states identified in the control message are joint uplink/downlink candidate TCI states or separate uplink only candidate TCI states or downlink only candidate TCI states.

In a fifth aspect, alone or in combination with one or more of the first through fourth aspects, one or more of the first field or the second field comprise a bitmap associated with the one or more fields for the TCI state identifications that are associated with the one or more activated candidate TCI states.

In a sixth aspect, alone or in combination with one or more of the first through fifth aspects, a first bit of the second field is ignored based at least in part on a first bit of the first field indicating activation of a candidate TCI state that is a joint uplink/downlink candidate TCI state, or wherein the first bit of the second field indicates, based at least in part on the first bit of the first field not indicating activation of the candidate TCI state that is the joint uplink/downlink candidate TCI state, whether one or more associated fields of the one or more fields indicate a candidate TCI state for an uplink only TCI state, for a downlink only TCI state, or for an uplink only TCI state and a downlink only TCI state.

In a seventh aspect, alone or in combination with one or more of the first through sixth aspects, the control message does not include the second field based at least in part on a configuration to activate or deactivate downlink only TCI states and uplink only TCI states together.

In an eighth aspect, alone or in combination with one or more of the first through seventh aspects, the control message comprises a content indication field that indicates whether the control message includes an indication of a TCI state to use as a downlink only TCI state.

In a ninth aspect, alone or in combination with one or more of the first through eighth aspects, the UE is configured for multiple TRP communication with the one or more base stations, and wherein the control message comprises a first TCI state identification for a first joint uplink/downlink TCI state associated with a first TRP and a second TCI state identification for a second joint uplink/downlink TCI state associated with a second TRP, or one or more of a third TCI state identification for an uplink only TCI state, a downlink only TCI state, or both downlink only and uplink only TCI states for the first TRP or the second TRP.

In a tenth aspect, alone or in combination with one or more of the first through ninth aspects, process 900 includes transmitting, in a communication subsequent to receiving the indication of the subset of the candidate TCI states, an indication of a candidate TCI state of the subset of the candidate TCI states for the communication.

In an eleventh aspect, alone or in combination with one or more of the first through tenth aspects, the control message applies to all serving cells configured in a set of serving cells having common candidate TCI states.

In a twelfth aspect, alone or in combination with one or more of the first through eleventh aspects, process 900 includes transmitting an indication of a configuration of the candidate TCI states for one or more serving cells in the set of serving cells, or transmitting, before transmitting the control message, an indication to remove at least one serving cell from the set of serving cells.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a communication manager 1008 (e.g., the communication manager 140). The communication manager 1008 may provide instructions to the reception component 1002 and/or the transmission component 1004 associated with communicating with the apparatus 1006.

In some aspects, the apparatus 1000 may be configured to perform one or more operations described herein in connection with FIGS. 4-5I. Additionally, or alternatively, the apparatus 1000 may be configured to perform one or more processes described herein, such as process 600 of FIG. 6, process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive an indication of candidate TCI states for communicating with one or more base stations. The reception component 1002 may receive an indication of a subset of the candidate TCI states for selection for a communication with the one or more base stations, the indication of the subset including an indication of whether one or more candidate TCI states of the subset of the candidate TCI states are joint uplink/downlink candidate TCI states.

The reception component 1002 may receive, in a communication subsequent to receiving the indication of the subset of the candidate TCI states, an indication of a candidate TCI state of the subset of the candidate TCI states for the communication.

The reception component 1002 may receive an indication of candidate TCI states for selection for a communication with one or more base stations. The reception component 1002 may receive a control message that indicates one or more of the candidate TCI states that are updated and that indicates an update to the one or more of the candidate TCI states.

The reception component 1002 may receive an indication of whether the one or more of the candidate TCI states that are updated include one or more of joint uplink/downlink candidate TCI states, downlink only candidate TCI states, uplink only candidate TCI states, or uplink only candidate TCI states and downlink only candidate TCI states.

The reception component 1002 may receive, in a communication subsequent to receiving the indication of the subset of the candidate TCI states, an indication of a candidate TCI state of the subset of the candidate TCI states for the communication.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a base station, or a base station may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include a communication manager 1108 (e.g., the communication manager 150). The communication manager 1108 may provide instructions to the reception component 1102 and/or the transmission component 1104 associated with communicating with the apparatus 1106.

In some aspects, the apparatus 1100 may be configured to perform one or more operations described herein in connection with FIGS. 4-5I. Additionally, or alternatively, the apparatus 1100 may be configured to perform one or more processes described herein, such as process 700 of FIG. 7, process 900 of FIG. 9, or a combination thereof. In some aspects, the apparatus 1100 and/or one or more components shown in FIG. 11 may include one or more components of the base station described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the base station described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the base station described in connection with FIG. 2. In some aspects, the transmission component 1104 may be co-located with the reception component 1102 in a transceiver.

The transmission component 1104 may transmit an indication of candidate TCI states for communicating with one or more base stations. The transmission component 1104 may transmit an indication of a subset of the candidate TCI states for selection for a communication with the one or more base stations, the indication of the subset including an indication of whether one or more candidate TCI states of the subset of the candidate TCI states are joint uplink/downlink candidate TCI states.

The transmission component 1104 may transmit, in a communication subsequent to transmitting the indication of the subset of the candidate TCI states, an indication of a candidate TCI state of the subset of the candidate TCI states for the communication.

The transmission component 1104 may transmit an indication of a serving cell in the set of serving cells within the indication of the subset of the candidate TCI states.

The transmission component 1104 may transmit, before transmitting the indication of the subset of the candidate TCI states, an indication to remove at least one serving cell from the set of serving cells.

The transmission component 1104 may transmit an indication of candidate TCI states for selection for a communication with one or more base stations. The transmission component 1104 may transmit a control message that indicates one or more of the candidate TCI states that are updated and that indicates an update to the one or more of the candidate TCI states.

The transmission component 1104 may transmit an indication of whether the one or more of the candidate TCI states that are updated include one or more of joint uplink/downlink candidate TCI states, downlink only candidate TCI states, uplink only candidate TCI states, or uplink only candidate TCI states and downlink only candidate TCI states.

The transmission component 1104 may transmit, in a communication subsequent to receiving the indication of the subset of the candidate TCI states, an indication of a candidate TCI state of the subset of the candidate TCI states for the communication.

The transmission component 1104 may transmit an indication of a configuration of the candidate TCI states for one or more serving cells in the set of serving cells.

The transmission component 1104 may transmit, before transmitting the control message, an indication to remove at least one serving cell from the set of serving cells.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving an indication of candidate transmission configuration indicator (TCI) states for communicating with one or more base stations; and receiving an indication of a subset of the candidate TCI states for selection for a communication with the one or more base stations, the indication of the subset including an indication of whether one or more candidate TCI states of the subset of the candidate TCI states are joint uplink/downlink candidate TCI states.

Aspect 2: The method of Aspect 1, wherein receiving the indication of the candidate TCI states comprises: receiving the indication of the candidate TCI states via radio resource control (RRC) signaling.

Aspect 3: The method of any of Aspects 1-2, wherein receiving the indication of the subset of the candidate TCI states comprises: receiving the indication of the subset of the candidate TCI states via medium access control (MAC) control element (CE) signaling.

Aspect 4: The method of any of Aspects 1-3, wherein receiving the indication of the subset of the candidate TCI states comprises receiving the indication of the subset of the candidate TCI states via a control message, the control message comprising one or more of: a first field for indicating activation of one or more candidate TCI states that are joint uplink/downlink candidate TCI states, a second field for indicating activation of one or more candidate TCI states that are uplink only candidate TCI states or downlink only candidate TCI states, one or more fields for TCI state identifications associated with one or more activated candidate TCI states, an indication of whether all candidate TCI states identified in the control message are joint uplink/downlink candidate TCI states or separate uplink only candidate TCI states or downlink only candidate TCI states, an indication of whether one or more previously configured candidate TCI states are updated via the control message, an indication of an update to the one or more previously configured candidate TCI states, or an indication of a type of TCI state that is indicated in the subset of the candidate TCI states.

Aspect 5: The method of Aspect 4, wherein one or more of the first field or the second field comprise a bitmap associated with the one or more fields for the TCI state identifications that are associated with the one or more activated candidate TCI states.

Aspect 6: The method of any of Aspects 4-5, wherein a first bit of the second field is ignored based at least in part on a first bit of the first field indicating activation of a candidate TCI state that is a joint uplink/downlink candidate TCI state, or wherein the first bit of the second field indicates, based at least in part on the first bit of the first field not indicating activation of the candidate TCI state that is the joint uplink/downlink candidate TCI state, whether one or more associated fields of the one or more fields indicate a candidate TCI state for an uplink only TCI state, for a downlink only TCI state, or for an uplink only TCI state and a downlink only TCI state.

Aspect 7: The method of Aspect 6, wherein the control message comprises: a content indication field that indicates whether the control message includes an indication of an additional TCI state to use for another of an uplink only TCI state or a downlink only TCI state.

Aspect 8: The method of any of Aspects 4-7, wherein the control message does not include the second field based at least in part on a configuration to activate or deactivate downlink only TCI states and uplink only TCI states together.

Aspect 9: The method of any of Aspects 4-8, wherein the control message comprises: a third field for indicating whether candidate TCI states indicated in the first field or the second field are activated or deactivated.

Aspect 10: The method of any of Aspects 4-9, wherein the UE is configured for multiple transmission reception point (TRP) communication with the one or more base stations, and wherein the control message comprises: a first TCI state identification for a first joint uplink/downlink TCI state associated with a first TRP and a second TCI state identification for a second joint uplink/downlink TCI state associated with a second TRP, or one or more of a third TCI state identification for an uplink only TCI state, a downlink only TCI state, or both downlink only and uplink only TCI states for the first TRP or the second TRP.

Aspect 11: The method of any of Aspects 1-10, wherein the subset of the candidate TCI states comprises a single candidate TCI state, and wherein the method further comprises selecting the single candidate TCI state for the communication with the one or more base stations based at least in part on the subset of the candidate TCI states comprising the single candidate TCI state.

Aspect 12: The method of any of Aspects 1-11, further comprising: receiving, in a communication subsequent to receiving the indication of the subset of the candidate TCI states, an indication of a candidate TCI state of the subset of the candidate TCI states for the communication.

Aspect 13: The method of any of Aspects 1-12, wherein the indication of the subset of the candidate TCI states applies to all serving cells configured in a set of serving cells having common candidate TCI states.

Aspect 14: The method of Aspect 13, wherein the indication of the subset of the candidate TCI states applies to all serving cells configured in the set of serving cells based at least in part on: the indication of the subset of the candidate TCI states indicating a cell identification, and the cell identification being indicated in the set of serving cells via a configuration message.

Aspect 15: A method of wireless communication performed by a base station, comprising: transmitting an indication of candidate transmission configuration indicator (TCI) states for communicating with one or more base stations; and transmitting an indication of a subset of the candidate TCI states for selection for a communication with the one or more base stations, the indication of the subset including an indication of whether one or more candidate TCI states of the subset of the candidate TCI states are joint uplink/downlink candidate TCI states.

Aspect 16: The method of Aspect 15, wherein transmitting the indication of the candidate TCI states comprises: transmitting the indication of the candidate TCI states via radio resource control (RRC) signaling.

Aspect 17: The method of any of Aspects 15-16, wherein transmitting the indication of the subset of the candidate TCI states comprises: transmitting the indication of the subset of the candidate TCI states via medium access control (MAC) control element (CE) signaling.

Aspect 18: The method of any of Aspects 15-17, wherein transmitting the indication of the subset of the candidate TCI states comprises transmitting the indication of the subset of the candidate TCI states via a control message, the control message comprising one or more of: a first field for indicating activation of one or more candidate TCI states that are joint uplink/downlink candidate TCI states, a second field for indicating activation of one or more candidate TCI states that are uplink only candidate TCI states or downlink only candidate TCI states, one or more fields for TCI state identifications associated with one or more activated candidate TCI states, an indication of whether all candidate TCI states identified in the control message are joint uplink/downlink candidate TCI states or separate uplink only candidate TCI states or downlink only candidate TCI states, an indication of whether one or more previously configured candidate TCI states are updated via the control message, an indication of an update to the one or more previously configured candidate TCI states, or an indication of a type of TCI state that is indicated in the subset of the candidate TCI states.

Aspect 19: The method of Aspect 18, wherein one or more of the first field or the second field comprise a bitmap associated with the one or more fields for the TCI state identifications that are associated with the one or more activated candidate TCI states.

Aspect 20: The method of any of Aspects 18-19, wherein a first bit of the second field is ignored based at least in part on a first bit of the first field indicating activation of a candidate TCI state that is a joint uplink/downlink candidate TCI state, or wherein the first bit of the second field indicates, based at least in part on the first bit of the first field not indicating activation of the candidate TCI state that is the joint uplink/downlink candidate TCI state, whether one or more associated fields of the one or more fields indicate a candidate TCI state for an uplink only TCI state, for a downlink only TCI state, or for an uplink only TCI state and a downlink only TCI state.

Aspect 21: The method of Aspect 20, wherein the control message comprises: a content indication field that indicates whether the control message includes an indication of an additional TCI state to use for another of an uplink only TCI state or a downlink only TCI state.

Aspect 22: The method of any of Aspects 18-21, wherein the control message does not include the second field based at least in part on a configuration to activate or deactivate downlink only TCI states and uplink only TCI states together.

Aspect 23: The method of any of Aspects 18-22, wherein the control message comprises: a third field for indicating whether candidate TCI states indicated in the first field or the second field are activated or deactivated.

Aspect 24: The method of any of Aspects 18-23, wherein the UE is configured for multiple transmission reception point (TRP) communication with the base station, and wherein the control message comprises: a first TCI state identification for a first joint uplink/downlink TCI state associated with a first TRP and a second TCI state identification for a second joint uplink/downlink TCI state associated with a second TRP, or one or more of a third TCI state identification for an uplink only TCI state, a downlink only TCI state, or both downlink only and uplink only TCI states for the first TRP or the second TRP.

Aspect 25: The method of any of Aspects 15-24, wherein the subset of the candidate TCI states comprises a single candidate TCI state, and wherein the subset of the candidate TCI states comprising the single candidate TCI states indicates that the UE is to select the single candidate TCI state for the communication with the base station.

Aspect 26: The method of any of Aspects 15-25, further comprising: transmitting, in a communication subsequent to transmitting the indication of the subset of the candidate TCI states, an indication of a candidate TCI state of the subset of the candidate TCI states for the communication.

Aspect 27: The method of any of Aspects 15-26, wherein the indication of the subset of the candidate TCI states applies to all serving cells configured in a set of serving cells having common candidate TCI states.

Aspect 28: The method of Aspect 27, wherein the indication of the subset of the candidate TCI states applies to all serving cells configured in the set of serving cells based at least in part on: the indication of the subset of the candidate TCI states indicating a cell identification, and the cell identification being indicated in the set of serving cells via a configuration message.

Aspect 29: The method of any of Aspects 27-28, further comprising: transmitting an indication of a serving cell in the set of serving cells within the indication of the subset of the candidate TCI states, or transmitting, before transmitting the indication of the subset of the candidate TCI states, an indication to remove at least one serving cell from the set of serving cells.

Aspect 30: A method of wireless communication performed by a user equipment (UE), comprising: receiving an indication of candidate transmission configuration indicator (TCI) states for selection for a communication with one or more base stations; and receiving a control message that indicates one or more of the candidate TCI states that are updated and that indicates an update to the one or more of the candidate TCI states.

Aspect 31: The method of Aspect 30, wherein receiving the indication of the candidate TCI states comprises: receiving the indication of the candidate TCI states via radio resource control (RRC) signaling.

Aspect 32: The method of any of Aspects 30-31, wherein receiving the control message comprises: receiving the control message via medium access control (MAC) control element (CE) signaling.

Aspect 33: The method of any of Aspects 30-32, further comprising receiving an indication of whether the one or more of the candidate TCI states that are updated include one or more of: joint uplink/downlink candidate TCI states, downlink only candidate TCI states, uplink only candidate TCI states, or uplink only candidate TCI states and downlink only candidate TCI states.

Aspect 34: The method of any of Aspects 30-33, wherein the control message comprises one or more of: a first field for indicating activation of one or more candidate TCI states that are joint uplink/downlink candidate TCI states, a second field for indicating activation of one or more candidate TCI states that are uplink only candidate TCI states or downlink only candidate TCI states, one or more fields for TCI state identifications associated with one or more activated candidate TCI states, an indication of whether all candidate TCI states identified in the control message are joint uplink/downlink candidate TCI states or separate uplink only candidate TCI states or downlink only candidate TCI states.

Aspect 35: The method of Aspect 34, wherein one or more of the first field or the second field comprise a bitmap associated with the one or more fields for the TCI state identifications that are associated with the one or more activated candidate TCI states.

Aspect 36: The method of any of Aspects 34-35, wherein a first bit of the second field is ignored based at least in part on a first bit of the first field indicating activation of a candidate TCI state that is a joint uplink/downlink candidate TCI state, or wherein the first bit of the second field indicates, based at least in part on the first bit of the first field not indicating activation of the candidate TCI state that is the joint uplink/downlink candidate TCI state, whether one or more associated fields of the one or more fields indicate a candidate TCI state for an uplink only TCI state, for a downlink only TCI state, or for an uplink only TCI state and a downlink only TCI state.

Aspect 37: The method of any of Aspects 34-36, wherein the control message does not include the second field based at least in part on a configuration to activate or deactivate downlink only TCI states and uplink only TCI states together.

Aspect 38: The method of any of Aspects 30-37, wherein the control message comprises: a content indication field that indicates whether the control message includes an indication of a TCI state to use as a downlink only TCI state.

Aspect 39: The method of any of Aspects 30-38, wherein the UE is configured for multiple transmission reception point (TRP) communication with the one or more base stations, and wherein the control message comprises: a first TCI state identification for a first joint uplink/downlink TCI state associated with a first TRP and a second TCI state identification for a second joint uplink/downlink TCI state associated with a second TRP, or one or more of a third TCI state identification for an uplink only TCI state, a downlink only TCI state, or both downlink only and uplink only TCI states for the first TRP or the second TRP.

Aspect 40: The method of any of Aspects 30-39, further comprising: receiving, in a communication subsequent to receiving the indication of the subset of the candidate TCI states, an indication of a candidate TCI state of the subset of the candidate TCI states for the communication.

Aspect 41: The method of any of Aspects 30-40, wherein the control message applies to all serving cells configured in a set of serving cells having common candidate TCI states.

Aspect 42: A method of wireless communication performed by a base station, comprising: transmitting an indication of candidate transmission configuration indicator (TCI) states for selection for a communication with one or more base stations; and transmitting a control message that indicates one or more of the candidate TCI states that are updated and that indicates an update to the one or more of the candidate TCI states.

Aspect 43: The method of Aspect 42, wherein transmitting the indication of the candidate TCI states comprises: transmitting the indication of the candidate TCI states via radio resource control (RRC) signaling.

Aspect 44: The method of any of Aspects 42-43, wherein transmitting the control message comprises: receiving the control message via medium access control (MAC) control element (CE) signaling.

Aspect 45: The method of any of Aspects 42-44, further comprising transmitting an indication of whether the one or more of the candidate TCI states that are updated include one or more of: joint uplink/downlink candidate TCI states, downlink only candidate TCI states, uplink only candidate TCI states, or uplink only candidate TCI states and downlink only candidate TCI states.

Aspect 46: The method of any of Aspects 42-45, wherein the control message comprises one or more of: a first field for indicating activation of one or more candidate TCI states that are joint uplink/downlink candidate TCI states, a second field for indicating activation of one or more candidate TCI states that are uplink only candidate TCI states or downlink only candidate TCI states, one or more fields for TCI state identifications associated with one or more activated candidate TCI states, an indication of whether all candidate TCI states identified in the control message are joint uplink/downlink candidate TCI states or separate uplink only candidate TCI states or downlink only candidate TCI states.

Aspect 47: The method of Aspect 46, wherein one or more of the first field or the second field comprise a bitmap associated with the one or more fields for the TCI state identifications that are associated with the one or more activated candidate TCI states.

Aspect 48: The method of any of Aspects 46-47, wherein a first bit of the second field is ignored based at least in part on a first bit of the first field indicating activation of a candidate TCI state that is a joint uplink/downlink candidate TCI state, or wherein the first bit of the second field indicates, based at least in part on the first bit of the first field not indicating activation of the candidate TCI state that is the joint uplink/downlink candidate TCI state, whether one or more associated fields of the one or more fields indicate a candidate TCI state for an uplink only TCI state, for a downlink only TCI state, or for an uplink only TCI state and a downlink only TCI state.

Aspect 49: The method of any of Aspects 46-48, wherein the control message does not include the second field based at least in part on a configuration to activate or deactivate downlink only TCI states and uplink only TCI states together.

Aspect 50: The method of any of Aspects 42-49, wherein the control message comprises: a content indication field that indicates whether the control message includes an indication of a TCI state to use as a downlink only TCI state.

Aspect 51: The method of any of Aspects 42-50, wherein the UE is configured for multiple transmission reception point (TRP) communication with the one or more base stations, and wherein the control message comprises: a first TCI state identification for a first joint uplink/downlink TCI state associated with a first TRP and a second TCI state identification for a second joint uplink/downlink TCI state associated with a second TRP, or one or more of a third TCI state identification for an uplink only TCI state, a downlink only TCI state, or both downlink only and uplink only TCI states for the first TRP or the second TRP.

Aspect 52: The method of any of Aspects 42-51, further comprising: transmitting, in a communication subsequent to receiving the indication of the subset of the candidate TCI states, an indication of a candidate TCI state of the subset of the candidate TCI states for the communication.

Aspect 53: The method of any of Aspects 42-52, wherein the control message applies to all serving cells configured in a set of serving cells having common candidate TCI states.

Aspect 54: The method of Aspect 53, further comprising: transmitting an indication of a configuration of the candidate TCI states for one or more serving cells in the set of serving cells, or transmitting, before transmitting the control message, an indication to remove at least one serving cell from the set of serving cells.

Aspect 55: An apparatus for wireless communication at a device, comprising a processor; memory coupled with the processor; and instructions stored in the memory and executable by the processor to cause the apparatus to perform the method of one or more of Aspects 1-54.

Aspect 56: A device for wireless communication, comprising a memory and one or more processors coupled to the memory, the one or more processors configured to perform the method of one or more of Aspects 1-54.

Aspect 57: An apparatus for wireless communication, comprising at least one means for performing the method of one or more of Aspects 1-54.

Aspect 58: A non-transitory computer-readable medium storing code for wireless communication, the code comprising instructions executable by a processor to perform the method of one or more of Aspects 1-54.

Aspect 59: A non-transitory computer-readable medium storing a set of instructions for wireless communication, the set of instructions comprising one or more instructions that, when executed by one or more processors of a device, cause the device to perform the method of one or more of Aspects 1-54.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors coupled to the memory, wherein the memory includes instructions executable by the one or more processors to cause the UE to:
receive an indication of candidate transmission configuration indicator (TCI) states for communicating with one or more base stations; and
receive an indication of a subset of the candidate TCI states for selection for a communication with the one or more base stations, the indication of the subset including an indication of whether one or more candidate TCI states of the subset of the candidate TCI states are joint uplink/downlink candidate TCI states.

2. The UE of claim 1, wherein the instructions, when receiving the indication of the candidate TCI states, are further executable by the one or more processors to cause the UE to:
receive the indication of the candidate TCI states via radio resource control (RRC) signaling.

3. The UE of claim 1, wherein the instructions, when receiving the indication of the subset of the candidate TCI states, are further executable by the one or more processors to cause the UE to:
receive the indication of the subset of the candidate TCI states via medium access control (MAC) control element (CE) signaling.

4. The UE of claim 1, wherein the instructions, when receiving the indication of the subset of the candidate TCI states, are further executable by the one or more processors to cause the UE to receive the indication of the subset of the candidate TCI states via a control message, the control message comprising one or more of:
a first field for indicating activation of one or more candidate TCI states that are joint uplink/downlink candidate TCI states,
a second field for indicating activation of one or more candidate TCI states that are uplink only candidate TCI states or downlink only candidate TCI states,
one or more fields for TCI state identifications associated with one or more activated candidate TCI states,
an indication of whether all candidate TCI states identified in the control message are joint uplink/downlink candidate TCI states or separate uplink only candidate TCI states or downlink only candidate TCI states,
an indication of whether one or more previously configured candidate TCI states are updated via the control message,
an indication of an update to the one or more previously configured candidate TCI states, or
an indication of a type of TCI state that is indicated in the subset of the candidate TCI states.

5. The UE of claim 4, wherein one or more of the first field or the second field comprise a bitmap associated with the one or more fields for the TCI state identifications that are associated with the one or more activated candidate TCI states.

6. The UE of claim 4, wherein a first bit of the second field is ignored based at least in part on a first bit of the first field indicating activation of a candidate TCI state that is a joint uplink/downlink candidate TCI state, or
wherein the first bit of the second field indicates, based at least in part on the first bit of the first field not indicating activation of the candidate TCI state that is the joint uplink/downlink candidate TCI state, whether one or more associated fields of the one or more fields indicate a candidate TCI state for an uplink only TCI state, for a downlink only TCI state, or for an uplink only TCI state and a downlink only TCI state.

7. The UE of claim 6, wherein the control message comprises:
a content indication field that indicates whether the control message includes an indication of an additional TCI state to use for another of an uplink only TCI state or a downlink only TCI state.

8. The UE of claim 4, wherein the control message does not include the second field based at least in part on a configuration to activate or deactivate downlink only TCI states and uplink only TCI states together.

9. The UE of claim 4, wherein the control message comprises:
a third field for indicating whether candidate TCI states indicated in the first field or the second field are activated or deactivated.

10. The UE of claim 4, wherein the UE is configured for multiple transmission reception point (TRP) communication with the one or more base stations, and
wherein the control message comprises:
a first TCI state identification for a first joint uplink/downlink TCI state associated with a first TRP and a second TCI state identification for a second joint uplink/downlink TCI state associated with a second TRP, or
one or more of a third TCI state identification for an uplink only TCI state, a downlink only TCI state, or both downlink only and uplink only TCI states for the first TRP or the second TRP.

11. The UE of claim 1, wherein the subset of the candidate TCI states comprises a single candidate TCI state, and
wherein the method further comprises selecting the single candidate TCI state for the communication with the one or more base stations based at least in part on the subset of the candidate TCI states comprising the single candidate TCI state.

12. The UE of claim 1, wherein the instructions are further executable by the one or more processors to cause the UE to:
receive, in a communication subsequent to receiving the indication of the subset of the candidate TCI states, an indication of a candidate TCI state of the subset of the candidate TCI states for the communication.

13. The UE of claim 1, wherein the indication of the subset of the candidate TCI states applies to all serving cells configured in a set of serving cells having common candidate TCI states.

14. The UE of claim 13, wherein the indication of the subset of the candidate TCI states applies to all serving cells configured in the set of serving cells based at least in part on:
the indication of the subset of the candidate TCI states indicating a cell identification, and
the cell identification being indicated in the set of serving cells via a configuration message.

15. A base station for wireless communication, comprising:
a memory; and
one or more processors coupled to the memory, wherein the memory includes instructions executable by the one or more processors to cause the base station to:
transmit an indication of candidate transmission configuration indicator (TCI) states for communicating with one or more base stations; and
transmit an indication of a subset of the candidate TCI states for selection for a communication with the one or more base stations, the indication of the subset including an indication of whether one or more candidate TCI states of the subset of the candidate TCI states are joint uplink/downlink candidate TCI states.

16. The base station of claim 15, wherein the instructions, when transmitting the indication of the subset of the candidate TCI states, are further executable by the one or more processors to cause the base station to:
transmit the indication of the subset of the candidate TCI states via medium access control (MAC) control element (CE) signaling.

17. The base station of claim 15, wherein the instructions, when transmitting the indication of the subset of the candidate TCI states, are further executable by the one or more processors to cause the base station to transmit the indication of the subset of the candidate TCI states via a control message, the control message comprising one or more of:
a first field for indicating activation of one or more candidate TCI states that are joint uplink/downlink candidate TCI states,
a second field for indicating activation of one or more candidate TCI states that are uplink only candidate TCI states or downlink only candidate TCI states,
one or more fields for TCI state identifications associated with one or more activated candidate TCI states,
an indication of whether all candidate TCI states identified in the control message are joint uplink/downlink candidate TCI states or separate uplink only candidate TCI states or downlink only candidate TCI states,
an indication of whether one or more previously configured candidate TCI states are updated via the control message,
an indication of an update to the one or more previously configured candidate TCI states, or
an indication of a type of TCI state that is indicated in the subset of the candidate TCI states.

18. The base station of claim 17, wherein one or more of the first field or the second field comprise a bitmap associated with the one or more fields for the TCI state identifications that are associated with the one or more activated candidate TCI states.

19. The base station of claim 17, wherein a first bit of the second field is ignored based at least in part on a first bit of the first field indicating activation of a candidate TCI state that is a joint uplink/downlink candidate TCI state, or
wherein the first bit of the second field indicates, based at least in part on the first bit of the first field not indicating activation of the candidate TCI state that is the joint uplink/downlink candidate TCI state, whether one or more associated fields of the one or more fields indicate a candidate TCI state for an uplink only TCI state, for a downlink only TCI state, or for an uplink only TCI state and a downlink only TCI state.

20. The base station of claim 19, wherein the control message comprises:
a content indication field that indicates whether the control message includes an indication of an additional TCI state to use for another of an uplink only TCI state or a downlink only TCI state.

21. The base station of claim 17, wherein the control message does not include the second field based at least in part on a configuration to activate or deactivate downlink only TCI states and uplink only TCI states together.

22. The base station of claim 17, wherein the control message comprises:
a third field for indicating whether candidate TCI states indicated in the first field or the second field are activated or deactivated.

23. The base station of claim 17, wherein a user equipment (UE) is configured for multiple transmission reception point (TRP) communication with the base station, and
wherein the control message comprises:
a first TCI state identification for a first joint uplink/downlink TCI state associated with a first TRP and a second TCI state identification for a second joint uplink/downlink TCI state associated with a second TRP, or
one or more of a third TCI state identification for an uplink only TCI state, a downlink only TCI state, or both downlink only and uplink only TCI states for the first TRP or the second TRP.

24. The base station of claim 15, wherein the subset of the candidate TCI states comprises a single candidate TCI state, and
wherein the subset of the candidate TCI states comprising the single candidate TCI states indicates that the UE is to select the single candidate TCI state for the communication with the base station.

25. The base station of claim 15, wherein the instructions are further executable by the one or more processors to cause the base station to:
transmit, in a communication subsequent to transmitting the indication of the subset of the candidate TCI states, an indication of a candidate TCI state of the subset of the candidate TCI states for the communication.

26. The base station of claim 15, wherein the indication of the subset of the candidate TCI states applies to all serving cells configured in a set of serving cells having common candidate TCI states.

27. The base station of claim 26, wherein the indication of the subset of the candidate TCI states applies to all serving cells configured in the set of serving cells based at least in part on:
the indication of the subset of the candidate TCI states indicating a cell identification, and
the cell identification being indicated in the set of serving cells via a configuration message.

28. The base station of claim 27, wherein the instructions are further executable by the one or more processors to cause the base station to:
transmit an indication of a serving cell in the set of serving cells within the indication of the subset of the candidate TCI states, or
transmit, before transmitting the indication of the subset of the candidate TCI states, an indication to remove at least one serving cell from the set of serving cells.

29. A method of wireless communication performed by a user equipment (UE), comprising:
receiving an indication of candidate transmission configuration indicator (TCI) states for communicating with one or more base stations; and
receiving an indication of a subset of the candidate TCI states for selection for a communication with the one or more base stations, the indication of the subset including an indication of whether one or more candidate TCI states of the subset of the candidate TCI states are joint uplink/downlink candidate TCI states.

30. A method of wireless communication performed by a base station, comprising:
transmitting an indication of candidate transmission configuration indicator (TCI) states for communicating with one or more base stations; and
transmitting an indication of a subset of the candidate TCI states for selection for a communication with the one or more base stations, the indication of the subset including an indication of whether one or more candidate TCI states of the subset of the candidate TCI states are joint uplink/downlink candidate TCI states.
